(19) United States
(12) Patent Application Publication
(10) Pub. No.: US 2025/0071668 A1
(43) Pub. Date: Feb. 27, 2025

(54) METHOD OF USER EQUIPMENT (UE), METHOD OF COMMUNICATION APPARATUS, AND UE

(71) Applicant: NEC Corporation, Minato-ku, Tokyo (JP)

(72) Inventors: Kundan TIWARI, Tokyo (JP); Toshiyuki TAMURA, Tokyo (JP); Iskren IANEV, Tokyo (JP)

(73) Assignee: NEC Corporation, Minato-ku, Tokyo (JP)

(21) Appl. No.: 18/710,706

(22) PCT Filed: Dec. 7, 2022
(86) PCT No.: PCT/JP2022/045181

§ 371 Date: May 16, 2024

(30) Foreign Application Priority Data
Dec. 9, 2021 (IN) 202111057371

(51) Int. Cl. H04W 48/18; H04W 36/08; H04W 60/04; H04W 64/00

(52) U.S. Cl. CPC H04W 48/18; H04W 36/08; H04W 60/04; H04W 64/00

(57) ABSTRACT

There is a service requirement defined in 3GPP TS 22.261. However, there is no clear mechanism defined in 3GPP specifications how the requirement can be realized. A method of a User Equipment (UE) includes sending first information indicating a first network slice which is available in a first network where the UE is located and second information indicating a second network slice which is required by a service or an application activated in the UE and is not available on the first network. The method includes receiving third information indicating a second network where the second network slice is available.

### TECHNICAL FIELD

This present disclosure relates to a method of a User Equipment (UE), a method of a communication apparatus, a UE and a communication apparatus.

### BACKGROUND ART

There is a following service requirement defined in NPL 2.
For a roaming UE activating a service/application requiring a network slice not offered by the serving network but available in the area from other network(s), the HPLMN shall be able to provide the UE with prioritization information of the VPLMNs with which the UE may register for the network slice.

### CITATION LIST

### Non Patent Literature

[NPL 1] 3GPP TR 21.905; “Vocabulary for 3GPP Specifications”. V17.0.0 (2020 July)

[NPL 2] 3GPP TS 22.261; “Service requirements for the 5G system”. V18.4.0 (2021 September)

[NPL 3] 3GPP TS 23.501; “System architecture for the 5G System (5GS)”. V17.2.0 (2021 September)

[NPL 4] 3GPP TS 23.502; “Procedures for the 5G System (5GS)”. V17.2.0 (2021 September)

[NPL 5] 3GPP TS 23.003; “Numbering, addressing and identification”. V17.3.0 (2021 September)

[NPL 6] 3GPP TS 38.413; “NG-RAN; NG Application Protocol (NGAP)”. V16.7.0 (2021 October)

[NPL 7] IETF RFC 5580; “Carrying Location Objects in RADIUS and Diameter”. (2009 August)

[NPL 8] 3GPP TS 33.501; “Security architecture and procedures for 5G system”. V17.3.0 (2021 September)

### SUMMARY OF INVENTION

### Technical Problem

However, there is no clear mechanism defined in 3GPP specifications how the requirement shown above can be realized.

### Solution to Problem

In an aspect of the present disclosure, a method of a User Equipment (UE) includes sending first information indicating a first network slice which is available in a first network where the UE is located and second information indicating a second network slice which is required by a service or an application activated in the UE and is not available on the first network. The method includes receiving third information indicating a second network where the second network slice is available.

In an aspect of the present disclosure, a method of a communication apparatus includes receiving first information indicating a first network slice which is available in a first network where a User equipment (UE) is located and second information indicating a second network slice which is required by a service or an application activated in the UE and is not available on the first network. The method includes sending third information indicating a second network where the second network slice is available.

In an aspect of the present disclosure, a method of a User Equipment (UE) includes receiving first information indicating a first network where a first network slice is available. The method includes sending second information indicating a second network slice which is available in a second network where the UE is located and third information indicating the first network slice which is required by a service or an application activated in the UE and is not available on the second network after receiving the first information.

In an aspect of the present disclosure, a method of a communication apparatus includes sending first information indicating a first network where a first network slice is available. The method includes receiving second information indicating a second network slice which is available in a second network where a User Equipment (UE) is located and third information indicating the first network slice which is required by a service or an application activated in the UE and is not available on the second network after sending the first information.

In an aspect of the present disclosure, a method of a User Equipment (UE) includes receiving a request to send first information indicating a first network slice which is available in a first network where the UE is located and second information indicating a second network slice which is required by a service or an application activated in the UE and is not available on the first network. The method includes sending the first information and the second information after receiving the request.

In an aspect of the present disclosure, a method of a communication apparatus includes sending a request to send first information indicating a first network slice which is available in a first network where a User Equipment (UE) is located and second information indicating a second network slice which is required by a service or an application activated in the UE and is not available on the first network. The method includes receiving the first information and the second information after sending the request.

In an aspect of the present disclosure, a method of a User Equipment (UE) includes sending first information indicating a first network slice to which the UE requests to register in a first network. The method includes receiving second information indicating a second network slice. The second network slice is a network slice to which the UE is subscribed and which is different from the first network slice and which is available in a second network.

In an aspect of the present disclosure, a method of a communication apparatus includes receiving first information indicating a first network slice to which a User Equipment (UE) requests to register in a first network. The method includes sending second information indicating a second network slice. The second network slice is a network slice to which the UE is subscribed and which is different from the first network slice and which is available in a second network.

In an aspect of the present disclosure, a User Equipment (UE) includes means for sending first information indicating a first network slice which is available in a first network where the UE is located and second information indicating a second network slice which is required by a service or an application activated in the UE and is not available on the first network. The UE includes means for receiving third information indicating a second network where the second network slice is available.

In an aspect of the present disclosure, a communication apparatus includes means for receiving first information indicating a first network slice which is available in a first network where a User equipment (UE) is located and second information indicating a second network slice which is required by a service or an application activated in the UE and is not available on the first network. The communication apparatus includes means for sending third information indicating a second network where the second network slice is available.

In an aspect of the present disclosure, a User Equipment (UE) includes means for receiving first information indicating a first network where a first network slice is available. The UE includes means for sending second information indicating a second network slice which is available in a second network where the UE is located and third information indicating the first network slice which is required by a service or an application activated in the UE and is not available on the second network after receiving the first information.

In an aspect of the present disclosure, a communication apparatus includes sending first information indicating a first network where a first network slice is available. The communication apparatus includes receiving second information indicating a second network slice which is available in a second network where a User Equipment (UE) is located and third information indicating the first network slice which is required by a service or an application activated in the UE and is not available on the second network after sending the first information.

In an aspect of the present disclosure, a User Equipment (UE) includes means for receiving a request to send first information indicating a first network slice which is available in a first network where the UE is located and second information indicating a second network slice which is required by a service or an application activated in the UE and is not available on the first network. The UE includes means for sending the first information and the second information after receiving the request.

In an aspect of the present disclosure, a communication apparatus includes means for sending a request to send first information indicating a first network slice which is available in a first network where a User Equipment (UE) is located and second information indicating a second network slice which is required by a service or an application activated in the UE and is not available on the first network. The communication apparatus includes means for receiving the first information and the second information after sending the request.

In an aspect of the present disclosure, a User Equipment (UE) includes means for sending first information indicating a first network slice to which the UE requests to register in a first network. The UE includes means for receiving second information indicating a second network slice. The second network slice is a network slice to which the UE is subscribed and which is different from the first network slice and which is available in a second network.

In an aspect of the present disclosure, a communication apparatus includes means for receiving first information indicating a first network slice to which a User Equipment (UE) requests to register in a first network. The communication apparatus includes means for sending second information indicating a second network slice. The second network slice is a network slice to which the UE is subscribed and which is different from the first network slice and which is available in a second network.

### BRIEF DESCRIPTION OF DRAWINGS

FIG. 1 illustrates new information in the UE for a cell selection and a cell reselection (Information in the UE for a cell selection and cell reselection based on network slice priority).

FIG. 2 illustrates slice information (Slice info).

FIG. 3 is a signaling diagram of a First example of the First Aspect (VPLMN selection based on network slice availability).

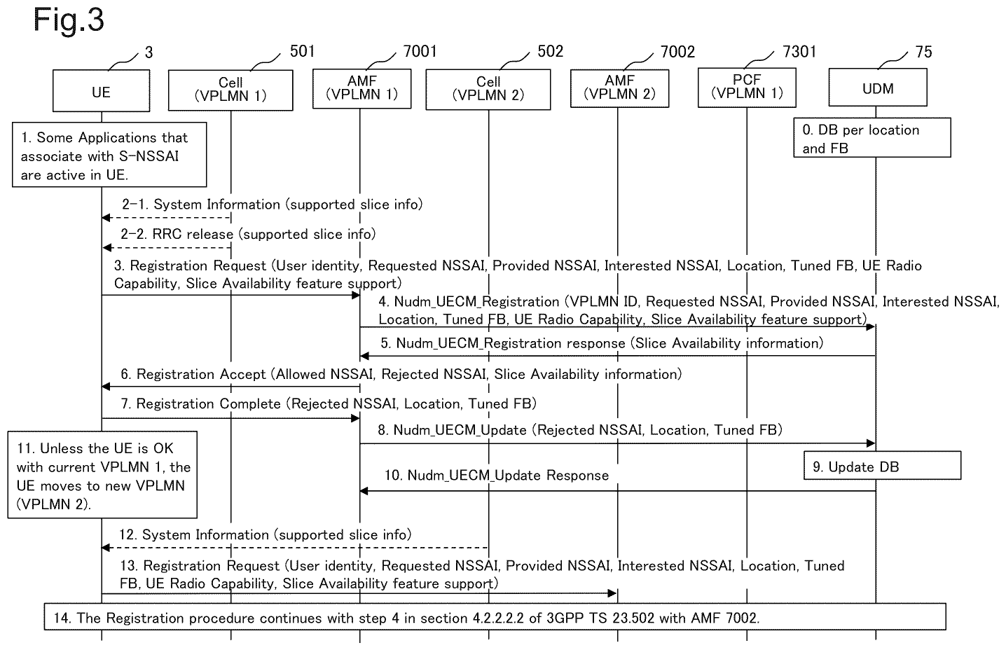

FIG. 4 is a signaling diagram of a Second example of the First Aspect (VPLMN selection based on network slice availability).

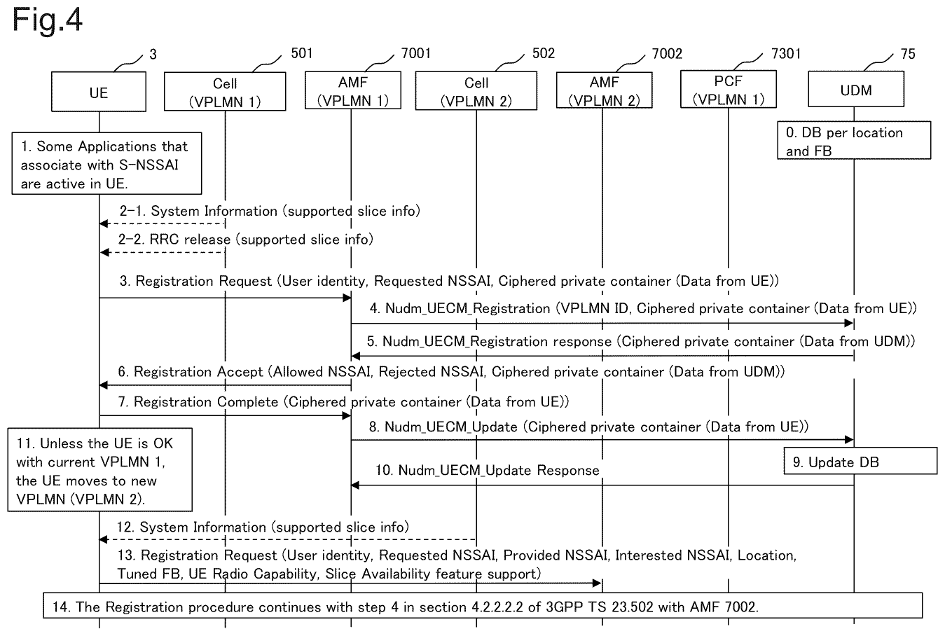

FIG. 5 is a signaling diagram of a Third example of the First Aspect (Secure data transfer from the UE to the UDM).

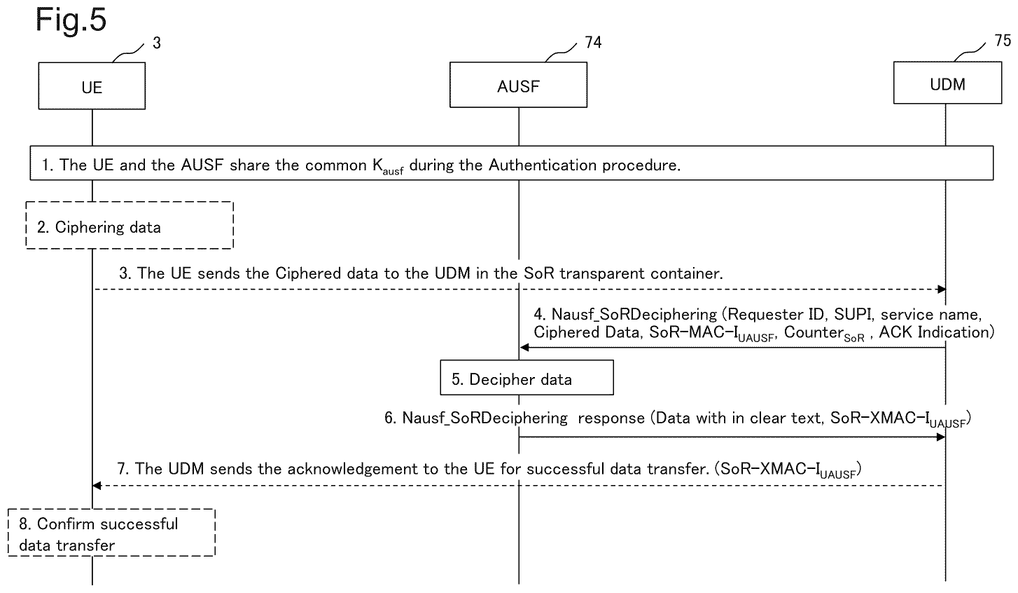

FIG. 6 is a signaling diagram of a Fourth example of the First Aspect (Handshaking network slice information between UE and UDM (Push mode)).

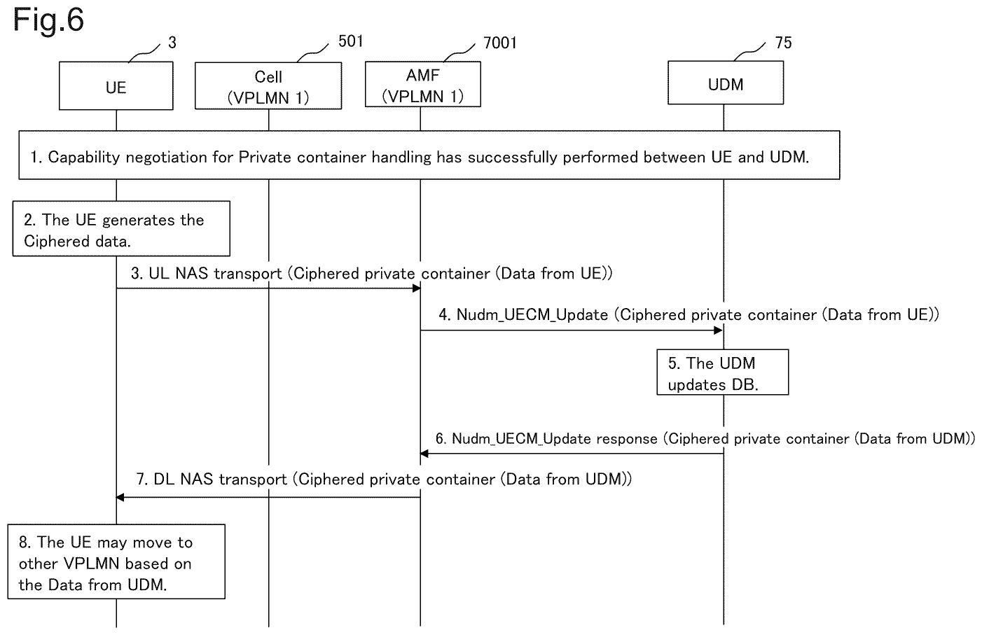

FIG. 7 is a signaling diagram of a Fifth example of the First Aspect (Handshaking network slice information between UE and UDM (Pull mode)).

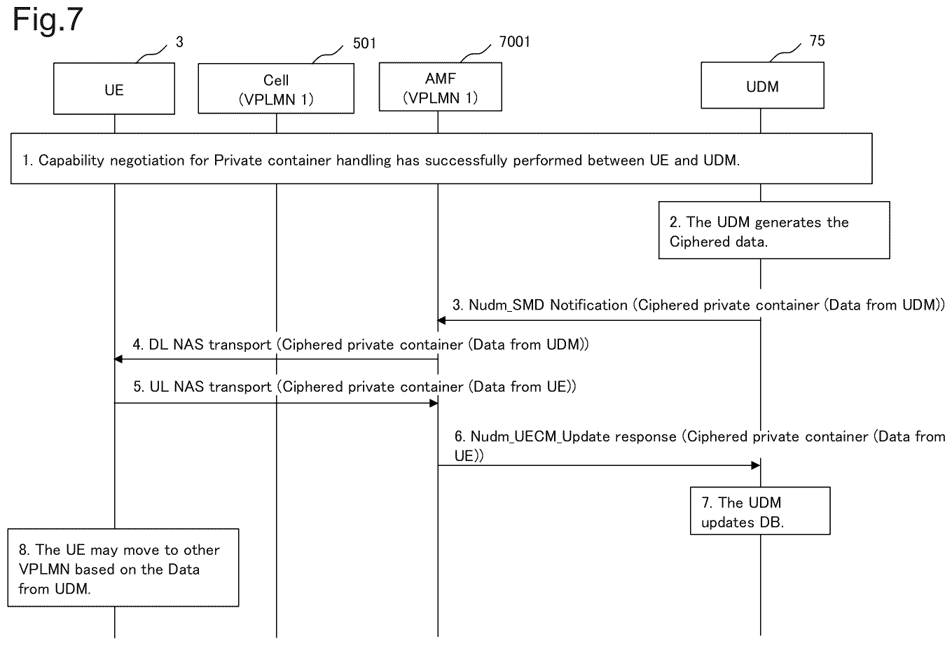

FIG. 8 is a signaling diagram of a First example of the Second Aspect (UE and Network status provisioning to UDM on demand).

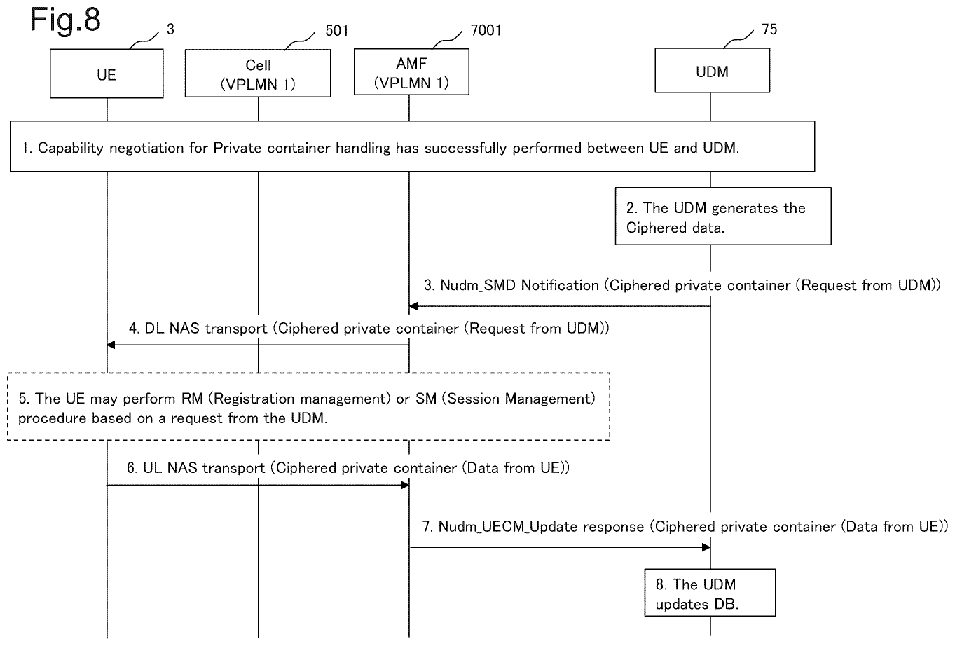

FIG. 9 is a signaling diagram of a First example of the Third Aspect (Available network selection in roaming via URSP rules update at registration).

FIG. 10 is a diagram illustrating a system overview.

FIG. 11 is a block diagram illustrating a User equipment (UE).

FIG. 12 is a block diagram illustrating an (R)AN node.

FIG. 13 is a diagram illustrating System overview of (R)AN node based on O-RAN architecture.

FIG. 14 is a block diagram illustrating a Radio Unit (RU).

FIG. 15 is a block diagram illustrating a Distributed Unit (DU).

FIG. 16 is a block diagram illustrating a Centralized Unit (CU).

FIG. 17 is a block diagram illustrating an Access and Mobility Management Function (AMF).

FIG. 18 is a block diagram illustrating a PCF.

FIG. 19 is a block diagram illustrating an AUSF.

FIG. 20 is a block diagram illustrating a Unified Data Management (UDM).

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
AMF-G Geographically selected Access and Mobility Management Function
AMF-NG Non-Geographically selected Access and Mobility Management Function
AS Access Stratum
ATSSS Access Traffic Steering, Switching, Splitting
ATSSS-LL ATSSS Low-Layer
AUSF Authentication Server Function
AUTN Authentication token
BCCH Broadcast Control Channel
BMCABest Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMFUE radio Capability Management Function
UDM Unified Data Management
UDR Unified Data Repository
UDSF Unstructured Data Storage Function
UE User Equipment
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### <General>

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

It is assumed that a User Equipment (UE) knows all network slice(s) available within a cell in a VPLMN when the UE is in CM-IDLE state, CM-CONNECTED state or CM-CONNECTED with RRC Inactive state.

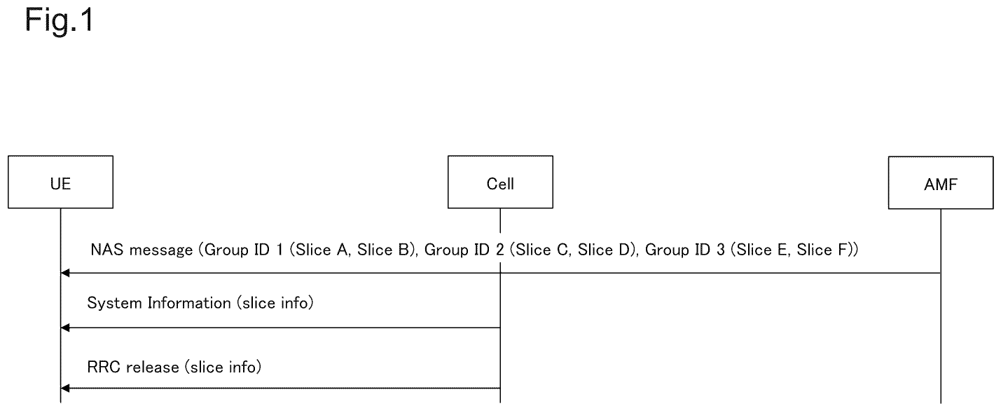

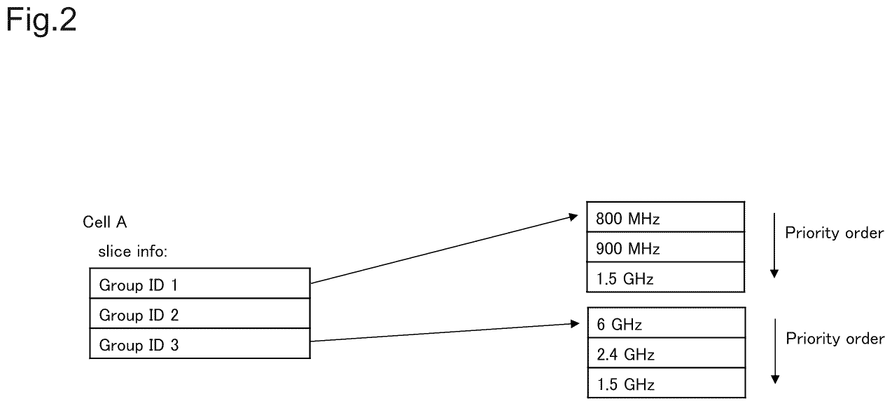

For example, the FIG. 1 and the FIG. 2 illustrate information provided to the UE by an AMF and a cell respectively. The UE can understand all network slice(s) available within the cell based on two information one from the AMF and the other one from the cell. For example, the UE receives a NAS message from the AMF. For example, the NAS message includes information indicating that a first Group which is identified by Group ID 1 includes network slice A and network slice B, a second Group which is identified by Group ID 2 includes network slice C and network slice D and a third Group which is identified by Group ID 3 includes network slice E and network slice F. In addition, the UE receives system information from a (R)AN node which controls a cell. The “cell” may mean “a (R)AN node which controls a cell”. For example, the (R)AN node may mean an NG-RAN node or a gNB. The system information includes slice info. The UE may receive an RRC release message from a (R)AN node. The slice info may be included in the RRC release message. For example, the slice info may be expressed as slice information. For example, the slice info includes Group ID 1, Group ID 2 and Group ID 3. The slice info may indicate Group ID(s) which are available in the cell. In examples of FIG. 1 and FIG. 2, the UE can understand that network slice A, network slice B, network slice C, network slice D, network slice E and network slice F are available within the cell based on the information included in the NAS message and the slice info included in the system information or the RRC release message.

In addition, the Group ID(s) in the slice info is associated with frequency information. In an example of the FIG. 2, Group ID 1 (or network slices A and network slice B in the first group identified by Group ID 1) is associated with 800 MHZ, 900 MHZ and 1.5 GHz in order of priority. For example, 800 MHz has the highest priority in Group ID 1. For example, 1.5 GHz has the lowest priority in Group ID 1. For example, 900 MHz has middle priority between 800 MHz and 1.5 GHz in Group ID 1.

The FIG. 1 illustrates an example of information available in the User Equipment (UE) for at least one of a cell selection and a cell reselection based on network slice priority.

The FIG. 2 explains an example of slice info that the cell broadcasts to the UE.

This disclosure enables an HPLMN operator to make the UE possible to select a VPLMN based on an availability of network slice(s) in each VPLMN(s) where the UE roams to. Prioritization information may be expressed as Slice Availability information. “S-NSSAI is available” may mean that “network slice identified by S-NSSAI is available”.

### <First Aspect>

In order to make a Home Public Land Mobile Network (HPLMN) operator possible to provide prioritization information for Visited Public Land Mobile Network(s) (VPLMN(s)) to a UE while the UE is roaming, it needs a mechanism in NPL 3, NPL 4 and other 3GPP specifications so that a UDM provides the prioritization information for the VPLMN(s) to the UE based on the location that the UE moved to.

In addition, it is known that 3GPP operators in general configure network slice(s) available in a cell based on a Frequency Band (FB) that the cell uses. If a network slice requires an extremely high bandwidth, it can only be provided by a cell with high FB. On the other hand, if a network slice requires to support UE(s) with high velocity and random movement, the UE(s) uses a cell with low FB as low FB provides a wide and flexible radio penetration. With this consideration in mind, it is beneficial for the UE(s) if the HPLMN provides the prioritization information of the VPLMN(s) that includes network slice information available together with FB information. Then, the UE can select a new VPLMN with the best FB that the UE wishes to access to a network slice that the UE is interested in.

This First Aspect discloses a mechanism that enables the HPLMN operator to provide the prioritization information for the VPLMN(s) to the UE while the UE is roaming. Within the provided prioritization information of the VPLMN(s), each VPLMN may have associated information including network slices available per location and per FB.

The First Aspect can solve the problem that there is no clear mechanism defined in 3GPP specifications how the requirement in NPL 2 can be realized.

### First Example of the First Aspect

First example of the First Aspect discloses a method where a UDM 75 provides prioritization information for the VPLMN(s) with network slice related information to a UE 3 in a Registration procedure.

In addition, the First example of the First Aspect discloses a mechanism where the UE 3 provides a VPLMN related information to the UDM 75 during the Registration procedure.

In order to make the First example of the First Aspect understandable, the First example of the First Aspect takes the following examples.

### For the UE 3;

The UE 3 has four applications installed, APL 1, APL 2, APL 3 and APL 4 and these applications have associated network slice S-NSSAI 1, S-NSSAI 2, S-NSSAI 3 and S-NSSAI 4 respectively based on a URSP rule in the UE 3.
The UE 3 has three applications APL 1, APL 2 and APL 3 active when the UE initiates the Registration Procedure to VPLMN 1. I.E., the UE 3 is interested in network slices S-NSSAI 1, S-NSSAI 2 and S-NSSAI 3 to be allowed to access by the VPLMN 1. The application(s) may be expressed as service(s). The application(s) may correspond service(s). For example, the UE 3 may activate APL 1, require Service 1 corresponds to APL 1 and perform a registration procedure corresponds to S-NSSAI 1.

### For VPLMN 1;

A Cell 501 supports network slices, S-NSSAI 1 and S-NSSAI 2. For example, The Cell 501 is controlled by a (R)AN node in the VPLMN 1. For example, the (R)AN node may mean an NG-RAN node or a gNB.

### For HPLMN of the UE 3;

The UDM 75 has a subscriber data for the UE 3 including S-NSSAI 1, S-NSSAI 2, S-NSSAI 3 and S-NSSAI 4 in subscribed NSSAI for the UE 3. For example, the UDM 75 is included in the HPLMN.

The detailed processes of the First example of the First Aspect are as described below.

Step 0. A UDM 75 in the HPLMN holds a Database (DB) based on an operator roaming agreement among roaming partners all over the world. The DB may include a list of roaming partners per location. The list of roaming partners may be expressed as a list of VPLMN(s). For example, the HPLMN has a roaming partners VPLMN 1, VPLMN 2, and VPLMN 3 in Tokyo, Japan with the priority order. For example, the list of roaming partners (or the list of VPLMN(s)) includes VPLMN 1, VPLMN 2, and VPLMN 3 in Tokyo, Japan with the priority order.

For each VPLMN entry in the list, the UDM 75 may hold S-NSSAI(s) available in the location together with FB(s). For example, in VPLMN 1 in Tokyo, S-NSSAI 1 and S-NSSAI 2 are available with 900 MHz Frequency Band. For example, the UDM 75 holds information indicating that S-NSSAI 1 and S-NSSAI 2 are available with 900 MHz Frequency Band in VPLMN 1 in Tokyo. For example, for each VPLMN entry in the list, the UDM 75 may hold S-NSSAI(s) available in the location. For example, for each VPLMN entry in the list, the UDM 75 may hold S-NSSAI(s) available in the location per RAN type. For example, the RAN type may be RAT type.

This DB is basically managed by an Operation and Maintenance (O&M) process. In addition to the O&M process, an HPLMN operator uses dynamic DB update based on an update mechanism as disclosed by this disclosure.

In addition, the UDM 75 has a subscriber data for the UE 3 including S-NSSAI 1, S-NSSAI 2, S-NSSAI 3 and S-NSSAI 4 in a subscribed NSSAI for the UE 3.

Step 1. A UE 3, as an inbound roamer for a VPLMN 1, has some applications active in the UE 3. Based on a URSP rule in the UE 3, the UE 3 knows which S-NSSAI(s) it needs to request to the VPLMN 1 in the Registration procedure. For example, there are four applications, APL 1, APL 2, APL 3 and APL 4 installed in the UE 3. Out of four applications, there are three applications APL 1, APL 2 and APL 3 active and S-NSSAI 1, S-NSSAI 2 and S-NSSAI 3 are associated network slices to each application respectively based on the URSP rule in the UE 3.

Step 2-1. The UE 3 may receive, from a Cell 501, system information indicating a list of supported S-NSSAI(s) by the Cell 501. The Cell 501 may be expressed as a (R)AN node, an NG-RAN node or a gNB controlling the Cell 501. For example, the Cell 501 supports S-NSSAI 1 and S-NSSAI 2. For example, in a case where the Cell 501 supports S-NSSAI 1 and S-NSSAI 2, the system information indicates the list which includes S-NSSAI 1 and S-NSSAI 2. For example, the system information includes the slice info which includes S-NSSAI 1 and S-NSSAI 2.

Step 2-2. The UE 3 may receive information of a list of supported S-NSSAI(s) by the Cell 501 in an RRC message. The RRC message may be an RRC release message or existing other RRC messages. For example, the Cell 501 supports S-NSSAI 1 and S-NSSAI 2. For example, in a case where the Cell 501 supports S-NSSAI 1 and S-NSSAI 2, the RRC message includes the list which includes S-NSSAI 1 and S-NSSAI 2. For example, the RRC message includes the slice info which includes S-NSSAI 1 and S-NSSAI 2. For example, the UE 3 may receive at least one of the system information in step 2-1 and the RRC message in step 2-2.

Step 3. The UE 3 sends a Registration Request message to an AMF 7001 including User identity, Requested NSSAI, Provided NSSAI, Interested NSSAI, Location, Tuned FB, UE Radio Capability and Slice Availability feature support parameter. The Registration Request message may include Available PLMNs list. The AMF 7001 is located in VPLMN 1. The following bullets explain a detail of each parameter.
User Identity may be a 5G-GUTI, SUCI or SUPI. For example, the User Identity may be a 5G-GUTI, SUCI or SUPI for the UE 3.
Requested NSSAI includes a list of S-NSSAI(s) that the UE 3 wishes to request to the VPLMN 1. In this example, the UE 3 populates S-NSSAI 1 and S-NSSAI 2 to the Requested NSSAI as the UE 3 knows, based on step 2-1 or step 2-2, that S-NSSAI 1 and S-NSSAI 2 are the network slices available with the Cell 501. I.E., although the UE 3 also wishes to request S-NSSAI 3 because an associated APL3 is active in the UE 3, the UE 3 does not request the S-NSSAI 3 as it is unlikely to be accepted by the AMF 7001 due to no support of the S-NSSAI 3 by the Cell 501. In this example, the Requested NSSAI includes S-NSSAI 1 and S-NSSAI 2.
Provided NSSAI may include a list of S-NSSAI(s) that are available in a cell of the VPLMN 1 where the UE 3 is camped on. In this example, the UE 3 may populate S-NSSAI 1 and S-NSSAI 2 based on information received in step 2-1 and step 2-2. In this example, the Provided NSSAI includes S-NSSAI 1 and S-NSSAI 2.

In one example, each S-NSSAI in the Provided NSSAI may have an associated information such as a list of FB(s) on which the S-NSSAI is available or deployed in the VPLMN 1. The UE 3 may obtain the Provided NSSAI in each FB by listening to a system information over each FB that the VPLMN 1 provides. The Provided NSSAI may be expressed as available S-NSSAI(s). For example, the UE 3 may associate the FB which the system information is broadcasted with the Provided NSSAI.

In another example, each S-NSSAI in the Provided NSSAI may have an associated information such as a list of FB(s) together with RAT type.

In another example, each S-NSSAI in the Provided NSSAI may have an associated information such as a list of FB(s) together with VPLMN ID that S-NSSAI is available in another VPLMN(s). The UE 3 may obtain available S-NSSAI(s) in FB in each VPLMN by listening a system information over each FB in each VPLMN.

Note that each S-NSSAI in the Provided NSSAI may have an associated information such as a combination of FB, RAT type and PLMN ID. For example, each S-NSSAI in the Provided NSSAI is associated with at least one of FB, RAT type and PLMN ID. The PLMN ID may mean VPLMN ID.
Interested NSSAI may include a list of S-NSSAI(s) that UE 3 is interested in. In this example, the UE 3 may populate S-NSSAI 1, S-NSSAI 2 and S-NSSAI 3 as APL 1, APL 2 and APL 3 are active in the UE 3. For example, the Interested NSSAI may include S-NSSAI 1, S-NSSAI 2 and S-NSSAI 3. In one example the Interested NSSAI includes the S-NSSAI which the UE 3 wants to register to the VPLMN 1, but the S-NSSAI is not provided by the cell which the UE 3 is camped on. For example, the Interested NSSAI may include S-NSSAI 3.

Location may be a location of the UE 3. Location can be a geographical location of the UE 3. For example, Location can be a Tracking Area Identity (TAI), NR Cell Global Identity (NCGI) as defined in NPL 5, NR Cell Identity (NCI) as defined in NPL 5, E-UTRAN Cell Global Identifier (ECGI) as defined in NPL 5, Global Cable Identifier (GCI) as defined in NPL 5, a general City name, zip-code, formed with GPS location or a location expressed with civic and geospatial location formats as defined in NPL 7.
Tuned FB is a Frequency Band that the UE is currently tuned to. For example, Tuned FB is 800 MHZ, 900 MHZ or 6 GHZ.

In one example, Tuned FB may have an associated information such as a RAT type.
UE Radio Capability indicates Frequency Bands that the UE 3 supports. The UE Radio Capability may also indicate a combination of Frequency Band and RAT type that UE 3 supports.
Slice Availability feature support parameter indicates that the UE 3 supports the network slice availability feature. I.E., when the UE 3 receives a Slice Availability information from the UDM 75 via the AMF 7001, the UE 3 is able to process the Slice Availability information and select a VPLMN based on outcome of the process of the received Slice Availability information. For example, the network slice availability feature indicates that the UE 3 is able to process the Slice Availability information and select a VPLMN based on outcome of the process of the received Slice Availability information. Processing the Slice Availability information and selecting a VPLMN based on outcome of the process of the received Slice Availability information are described below.

The Slice Availability feature support parameter may be expressed as Slice Availability feature support.
Available PLMNs list; The UE 3 may also include list of available PLMN(s) at the location along with the network slice supported by the each PLMN in the Available PLMNs list, Frequency Band of each PLMN. The UE 3 gets the Available PLMNs list by scanning the radio frequency in 5GMM-IDLE mode or 5GMM-CONNECTED mode at the location to check available PLMN(s).

Step 4. The AMF 7001 sends an Nudm_UECM_Registration message to the UDM 75 including VPLMN ID, Requested NSSAI, Provided NSSAI, Interested NSSAI, Location, Tuned FB, UE Radio Capability and Slice Availability feature support parameter. The AMF 7001 may include Requested NSSAI, Provided NSSAI, Interested NSSAI, Location, Tuned FB, UE Radio Capability and Slice Availability feature support parameter if the AMF 7001 receives the Slice Availability feature support parameter in the Registration Request message in step 3 The Nudm_UECM_Registration message may include the Available PLMNs list. The following bullets explain in details each parameter.

VPLMN ID indicates a VPLMN which the UE 3 is registering to. For example, the VPLMN ID may be identity of the VPLMN 1 where the UE 3 is registering to. For example, the VPLMN ID indicates VPLMN 1 where the UE 3 is registering to.
Location may be the same as the Location in step 3. The AMF 7001 may generate Location parameter based on an information from the Cell 501. In this case, the Location may be a NCGI, NCI, TAI, N3IWF user location information, TNGF user location information, TWIF user location information, W-AGF user location information as defined in NPL 6.
Requested NSSAI, Provided NSSAI, Interested NSSAI, Tuned FB, UE Radio Capability, the Available PLMNs list and Slice Availability feature support parameter may be the same as the ones in step 3.

For example, the AMF 7001 may send the Nudm_UECM_Registration message in a case where the AMF 7001 receives, from the UE 3, the Registration Request message or any existing message between AMF and UE or a new message between AMF and UE.

Step 5. Based on information received in step 4, the UDM 75 updates the DB related to supported network slice information in VPLMN(s). For example, in a case where the UDM 75 receives the VPLMN ID 1 which identifies VPLMN 1 and Location which is set to Tokyo and Provided NSSAI including S-NSSAI 1 and S-NSSAI 2, the UDM 75 adds or updates an entry related to the VPLMN 1 in the list of roaming partners (or the list of VPLMN(s)). In this case, for example, the UDM 75 adds, to the list, the entry which indicates that S-NSSAI 1 and S-NSSAI 2 are available in VPLMN 1 in Tokyo. For example, in a case where the UDM 75 has already stored the entry regarding VPLMN 1, the UDM 75 updates the entry based on received information which indicates that S-NSSAI 1 and S-NSSAI 2 are available in VPLMN 1 in Tokyo. In addition, for example, in case of adding or updating the entry, the UDM 75 associates Frequency Band indicated by Tuned FB with the entry. For example, in a case where the Tuned FB indicates 800 MHZ, the UDM adds, to the list, the entry which indicates that S-NSSAI 1 and S-NSSAI 2 are available on 800 MHz in VPLMN 1 in Tokyo.

The UDM 75 sends an Nudm_UECM_Registration response message to the AMF 7001 including Slice Availability information if the Slice Availability feature support parameter is included in the Nudm_UECM_Registration message in step 4. The UDM 75 generates the Slice Availability information based on the received parameters in the Nudm_UECM_Registration message in step 4. The Slice Availability information indicates S-NSSAI(s) that are available to the UE 3 at the location where the UE 3 is located. For example, the Slice Availability information may take one of the following forms.
Prioritized list of VPLMN(s) with supported S-NSSAI(s). The prioritized list of VPLMN(s) may be generated by the UDM 75 based on VPLMN ID, the Location, the Provided NSSAI and Interested NSSAI that are received in step 4. For example, based on VPLMN ID, the Location, the Provided NSSAI and Interested NSSAI that are received in step 4, the UDM 75 is aware that the UE 3 is interested in S-NSSAI 1, S-NSSAI 2 and S-NSSAI 3 but the VPLMN 1 identified by the VPLMN ID may only allow S-NSSAI 1, S-NSSAI 2 to the UE 3. With this situation, the UDM 75 may choose VPLMN(s) that supports all of S-NSSAI 1, S-NSSAI 2 and S-NSSAI 3 and generates the prioritized list based on the roaming agreements with VPLMN(s). For example, the prioritized list of VPLMN(s) includes VPLMN(s) that supports all of S-NSSAI 1, S-NSSAI 2 and S-NSSAI 3 on the location. For example, the prioritized list of VPLMN(s) may indicate VPLMN 2 that supports all of S-NSSAI 1, S-NSSAI 2 and S-NSSAI 3 on the location.
Prioritized list of VPLMN(s) with supported S-NSSAI(s) together with FB information. In addition to the bullet above, the UDM 75 takes the Provided NSSAI with FB and UE Radio Capability into account. For example, the prioritized list of VPLMN(s) includes VPLMN(s) that supports all of S-NSSAI 1, S-NSSAI 2 and S-NSSAI 3 on Tuned FB and the Location received in step 4. As this example provides the VPLMN together with FB information, the UE 3 can tune to a cell with the indicated FB in the indicated VPLMN. For example, the prioritized list of VPLMN(s) may indicate VPLMN 2 that supports all of S-NSSAI 1, S-NSSAI 2 and S-NSSAI 3 on the location and Tuned FB.
Prioritized list of VPLMN(s) with supported S-NSSAI(s) together with FB information with location for entire coverage of the VPLMN. In this example, the UDM 75 does not take Location information in step 4 into account. Instead, the UDM 75 generates a full set of Prioritized list of VPLMN(s) with supported S-NSSAI(s) together with FB information per locations where the VPLMN covers. The advantage of this example is that the UE 3 does not have to obtain the Slice Availability information as far as the UE 3 stays in the same VPLMN as full set of Prioritized list of VPLMN(s) is provided to the UE 3. A value of the Location may be the same as the Location in step 3. For example, the prioritized list of VPLMN(s) may indicate S-NSSAI(s) available in VPLMN 2 per location and FB. For example, the prioritized list of VPLMN(s) may indicate that first S-NSSAI is available on a first location and 800 MHz in a first VPLMN, and second S-NSSAI is available on the first location and 900 MHz in the first VPLMN, and third S-NSSAI is available on a second location and 800 MHZ in the first VPLMN, and fourth S-NSSAI is available on the second location and 900 MHz in the first VPLMN, and fifth S-NSSAI is available on the first location and 800 MHZ in a second VPLMN, and sixth S-NSSAI is available on the first location and 900 MHz in the second VPLMN, and seventh S-NSSAI is available on the second location and 800 MHz in the second VPLMN, and eighth S-NSSAI is available on the second location and 900 MHz in the second VPLMN.
Prioritized list of VPLMN(s) with supported S-NSSAI(s) based on the subscribed NSSAI. In this example, the UDM 75 takes the Requested NSSAI in step 4 and the subscribed NSSAI in the UDM 75 into account. When the UDM 75 refers to both the Requested NSSAI and the subscribed NSSAI, the UDM 75 safely understands a missing S-NSSAIs that the UE 3 has not yet allowed to access. In this example, the UDM 75 provides the Prioritized list of VPLMN(s) including VPLMN(s) with missing S-NSSAI(s). In this example, the Requested NSSAI has the S-NSSAI 1 and S-NSSAI 2 while the UDM 75 holds the S-NSSAI 1, S-NSSAI 2, S-NSSAI 3 and S-NSSAI 4 as the subscribed NSSAI for the UE 3. In this case, the UDM 75 understands that S-NSSAI 3 and S-NSSAI 4 are missing S-NSSAI(s). Therefore, the UDM 75 provides a Prioritized list of VPLMN(s) for S-NSSAI 3 and S-NSSAI 4. For example, the prioritized list of VPLMN(s) includes VPLMN(s) that supports S-NSSAI 3 and S-NSSAI 4.

The UDM 75 may generate the above prioritized list of VPLMN(s) which lists VPLMN(s) in priority order.

For example, the UDM 75 may send the Nudm_UECM_Registration response message in a case where the UDM 75 receives, from the AMF 7001, the Nudm_UECM_Registration message or any existing message between UDM and AMF or a new message between UDM and AMF.

For example, the UDM 75 may send the Nudm_UECM_Registration response message in a case where the UDM 75 updates the DB related to supported network slice information in VPLMN(s).

Step 6. The AMF 7001 sends a Registration Accept message to the UE 3 including the Slice Availability information that is received in the Nudm_UECM_Registration response message in step 5 from the UDM 75. In case that the AMF 7001 does not receive the Slice Availability feature support parameter from the UE 3 in the Registration Request message in step 3, the AMF 7001 does not include the Slice Availability information to the Registration Accept message. The Registration Accept message may include at least one of Allowed NSSAI and Rejected NSSAI.

For example, the AMF 7001 may send the Registration Accept message in a case where the AMF 7001 receives, from the UDM 75, the Nudm_UECM_Registration response message or any existing message between UDM and AMF or a new message between UDM and AMF.

Step 7. Upon reception of the Registration Accept message from the AMF 7001, the UE 3 sends a Registration Complete message to the AMF 7001 including Rejected NSSAI, Location, and Tuned FB. The following bullets explain a detail of each parameter.
Rejected NSSAI is a list of S-NSSAI(s) that are requested by the UE 3 but rejected by the AMF 7001. For example, the Rejected NSSAI may be a list of S-NSSAI(s) which is included in the Requested NSSAI but rejected by the AMF 7001. For example, the Rejected NSSAI may be same to the Rejected NSSAI included in the Registration Accept message.
Location, Tuned FB may be the same as the ones in step 3.

Note that each S-NSSAI in the Rejected NSSAI may have an associated information such as a combination of FB, RAT type and

PLMN ID. For example, each S-NSSAI in the Rejected NSSAI is associated with at least one of FB, RAT type and PLMN ID. For example, the PLMN ID may be VPLMN ID.

Step 8. Upon reception of the Registration Complete message from the UE 3, the AMF 7001 sends an Nudm_UECM_Update message to the UDM 75 including the Rejected NSSAI, Location and Tuned FB. The Rejected NSSAI, Location and Tuned FB included in the Nudm_UECM_Update message may be same as the ones received in step 7. The Nudm_UECM_Update message may include VPLMN ID indicating VPLMN which the UE 3 is registering to. For example, the VPLMN ID may be identity of the VPLMN 1 which the UE 3 is registering to. For example, the VPLMN ID indicates VPLMN 1 which the UE 3 is registering to.

Step 9. Based on information received in step 4 and step 8, the UDM 75 updates the DB related to supported network slice information in VPLMN(s). The UDM 75 stores the information, e.g., the Rejected NSSAI with corresponding VPLMN ID, RAT or FB supported by the UE 3. In one example when the UDM 75 determines that S-NSSAI(s) in the Rejected NSSAI is provided by another VPLMN 2 based on the DB in the UDM 75 or based on the Available PLMNs list, then the UDM 75 may send, to the AMF 7001, Nudm_UECM_Update Response message containing the Slice Availability information containing VPLMN 2 along with the S-NSSAI(s) as highest prioritized VPLMN.

Step 10. The UDM 75 sends an Nudm_UECM_Update Response message to the AMF 7001. When the AMF 7001 receives Slice Availability information in the Nudm_UECM_Update Response message, the AMF 7001 may send a new or existing NAS message to send the Slice Availability information to the UE 3.

For example, the UDM 75 may send the Nudm_UECM_Update Response message in a case where the UDM 75 receives, from the AMF 7001, the Nudm_UECM_Update message or any existing message between UDM and AMF or a new message between UDM and AMF.

For example, the UDM 75 may send the Nudm_UECM_Update Response message in a case where the UDM 75 updates the DB related to supported network slice information in VPLMN(s) based on information received in step 4 and step 8.

Step 11. The UE 3 examines the received Slice Availability information in the Registration Accept message in step 6 and makes a decision whether the UE 3 moves to a new VPLMN or not. For example, in a case where the received Slice Availability information indicates that VPLMN 2 supports S-NSSAI 1, S-NSSAI 2 and S-NSSAI 3 at FB 900 MHz, the UE 3 moves to a Cell 502 with FB 900 MHz in the VPLMN 2 as all active applications, APL 1, APL 2 and APL 3, in the UE 3 may have connections to associated Data Networks (DNs). In one example when a UE 3 finds in the Slice Availability information that another VPLMN 2 can provide a service to the S-NSSAI(s) in the Rejected NSSAI, the UE 3 may select the VPLMN 2 and initiate registration procedure to register for the S-NSSAI(s) which was rejected in the VPLMN 2. For example, in a case where the received Slice Availability information indicates that VPLMN 2 supports S-NSSAI 1, S-NSSAI 2 and S-NSSAI 3 at FB 900 MHz and VPLMN 2 has the highest priority among VPLMN(s) in the received Slice Availability information, the UE 3 moves to a Cell 502 with FB 900 MHz in the VPLMN 2.

Step 12. Once the UE 3 decided to move to the VPLMN 2, the UE 3 may listen to the Cell 502 and receive system information for making sure that S-NSSAI 1, S-NSSAI 2 and S-NSSAI 3 are supported.

Step 13. The UE 3 sends a Registration Request message to the AMF 7002 including User identity, Requested NSSAI, Provided NSSAI, Interested NSSAI, Location, Tuned FB, UE Radio Capability and Slice Availability feature support parameter. The AMF 7002 is located in VPLMN 2. For example, the Requested NSSAI in step 13 includes S-NSSAI 1, S-NSSAI 2 and S-NSSAI 3. For example, the Provided NSSAI in step 13 includes S-NSSAI 1, S-NSSAI 2 and S-NSSAI 3. For example, the Interested NSSAI in step 13 includes S-NSSAI 1, S-NSSAI 2 and S-NSSAI 3.

Step 14. The Registration procedure continues with step 4 in section 4.2.2.2.2 of NPL 4 with AMF 7002. In this example, the UE 3 is allowed to access to the S-NSSAI 1, S-NSSAI 2 and S-NSSAI 3 with the VPLMN 2. For example, in a case where the received Slice Availability information indicates that VPLMN 2 and VPLMN 3 support S-NSSAI 1, S-NSSAI 2 and S-NSSAI 3 at FB 900 MHz and VPLMN 2 has the highest priority and the VPLMN 3 has second priority among VPLMN(s) in the received Slice Availability information and the registration to the AMF 7002 in the VPLMN 2 is rejected, the UE 3 may move to a cell with FB 900 MHZ in the VPLMN 3.

The Provided NSSAI may expressed as a first network slice which is available in a first network where the UE 3 is located. The Interested NSSAI may be expressed as a second network slice which is required by a service or an application activated in the UE 3 and is not available on the first network where the UE 3 is located. The Slice Availability information may be expressed as information indicating a second network where the second network slice is available.

### Variant 1 of First Example of the First Aspect

When the AMF 7001 sends the Registration Accept message to the UE 3 in step 6, the AMF 7001 may send the Nudm_UECM_Update message to the UDM 75 including the Rejected NSSAI, Location and Tuned FB as shown as step 8 without waiting the Registration Complete message to come from the UE 3 in step 7.

### Variant 2 of First Example of the First Aspect

Instead of the Nudm_UECM_Registration message in step 4, the AMF 7001 sends Requested NSSAI, Provided NSSAI, Interested NSSAI, Location, Tuned FB, UE Radio Capability, Slice Availability feature support parameter to the UDM 75 by using the Nudm_SDM_Get message or any existing message between AMF and UDM or a new message between AMF and UDM.

### Variant 3 of First Example of the First Aspect

Instead of the Nudm_UECM_Registration response message in step 5, the UDM 75 sends the Slice Availability information parameters to the AMF 7001 by using the Nudm_SDM_Get response message or any existing message between AMF and UDM or a new message between AMF and UDM.

### Variant 4 of First Example of the First Aspect

In step 11, the UE 3 stores the received Slice Availability information in the Registration Accept message from the AMF 7001 for later use. If an application in the UE 3 requires a service to a network slice that the UE 3 is not currently registered for, the UE 3 analyses the stored Availability information and if the Slice Availability information reveals (or indicates) that the required network slice is now available on the same VPLMN in UE 3's current location or available on a different FB or available on a different VPLMN, the UE 3 triggers a registration procedure with the VPLMN and on the FB on which the required network slice is available.

### Second Example of the First Aspect

Second example of the First Aspect discloses a method that a UDM 75 provides prioritization information of the VPLMN(s) with network slice related information to a UE 3 in the Registration procedure using the ciphered private container between the UE 3 and the UDM 75.

In addition, the Second example of the First Aspect discloses a mechanism that the UE 3 provides a VPLMN related information to the UDM 75 during the Registration procedure.

In order to make the Second example of the First Aspect understandable, the Second example of the First Aspect takes the same examples with the First example of the First Aspect as shown below.

### For the UE 3;

The UE 3 has four applications installed, APL 1, APL 2, APL 3 and APL 4 and these applications have associated network slice S-NSSAI 1, S-NSSAI 2, S-NSSAI 3 and S-NSSAI 4 respectively based on the URSP rule in the UE 3.
The UE 3 has three applications APL 1, APL 2 and APL 3 active when the UE 3 initiates the Registration Procedure to the VPLMN 1. I.E., the UE 3 is interested in network slices S-NSSAI 1, S-NSSAI 2 and S-NSSAI 3 to be allowed to access by the VPLMN 1. The application(s) may be expressed as service(s). The application(s) may correspond service(s). For example, the UE 3 may activate APL 1, require Service 1 corresponds to APL 1 and perform a registration procedure corresponds to S-NSSAI 1.

### For VPLMN 1;

A Cell 501 supports network slices, S-NSSAI 1 and S-NSSAI 2.

### For HPLMN of the UE 3;

The UDM 75 has a subscriber data for the UE 3 including S-NSSAI 1, S-NSSAI 2, S-NSSAI 3 and S-NSSAI 4 in the subscribed NSSAI for the UE 3.

The detailed processes of the Second example of the First Aspect are as described below.

Step 0. This step is the same as the step 0 in the First example of the First Aspect.

In addition, the UDM 75 has an associated AUSF 74 for the UE 3. It means that the UE 3 and the AUSF 74 share the common K_{ausf}.

Step 1. This step is the same as the step 1 in the First example of the First Aspect.

In addition, the UE 3 holds the K_{ausf} that is shared with the AUSF 74.

Step 2-1. This step is the same as the step 2-1 in the First example of the First Aspect.

Step 2-2. This step is the same as the step 2-2 in the First example of the First Aspect.

Step 3. The UE 3 sends a Registration Request message to the AMF 7001 including User identity, Requested NSSAI, Slice Availability feature support and Ciphered private container parameter which includes Data from UE. The Ciphered private container parameter may be expressed as Ciphered private container. The Data from UE may be expressed as a Data from UE parameter. The UE 3 ciphers the Data from UE using the K_{ausf} that is held in the UE 3. The Data from UE may include Provided NSSAI, Interested NSSAI, Location, Tuned FB, UE Radio Capability and Slice Availability feature support parameter. For details of parameters in the Data from UE, it may refer to the bullets in the step 3 of the First example of the First Aspect. For example, the UE 3 ciphers the Data from UE including Provided NSSAI, Interested NSSAI, Location, Tuned FB, UE Radio Capability and Slice Availability feature support parameter, and includes the ciphered Data from UE in the Ciphered private container parameter.

It may refer to the Sixth example of the First Aspect for details of the Data from UE.

It may refer to the Third example of the First Aspect for details for ciphering of the Data from UE.

Step 4. The AMF 7001 sends an Nudm_UECM_Registration message to the UDM 75 including VPLMN ID, Ciphered private container which includes the Data from UE. For example, the Data from UE may be the ciphered Data from UE. The AMF 7001 may include the Ciphered private container in the Nudm_UECM_Registration message if the AMF 7001 receives the Slice Availability feature support parameter in the Registration Request message in Step 3. For details of parameters in the Data from UE, it may refer to the bullets in the step 4 of the First example of the First Aspect. The Nudm_UECM_Registration message may include the Requested NSSAI received in step 3.

For example, the AMF 7001 may send the Nudm_UECM_Registration message in a case where the AMF 7001 receives, from the UE 3, the Registration Request message or any existing message between AMF and UE or a new message between AMF and UE.

Step 5. Upon reception of the Nudm_UECM_Registration message from the AMF 7001, the UDM 75 sends an Nausf_SoRDeciphering message to the AUSF 74 including SoR header and Ciphered Information asking the AUSF 74 for deciphering the Ciphered information. The Ciphered Information includes the ciphered Data from UE. After the AUSF 74 performs the deciphering for the Data from UE as the Ciphered Information, the UDM 75 receives an Nausf_SoRDeciphering response message from the associated AUSF 74 including the Data from UDM with clear texts. For example, the Data from UDM with clear texts may mean deciphered or unencrypted Data from UDM. For example, the Data from UDM sent from the AUSF 74 is deciphered by the AUSF 74.

Based on information received in step 4, the UDM 75 updates the DB related to supported network slice information in VPLMN(s). For example, the UDM 75 may perform same process(es) in the step 5 of the First example of the First Aspect.

It may refer to the Third example of the First Aspect for details of interworking between the UDM 75 and the AUSF 74.

The UDM 75 sends an Nudm_UECM_Registration response message to the AMF 7001 including Ciphered private container including Data from UDM if the Slice Availability feature support parameter is included in the Ciphered private container including Data from UE that is received in the Nudm_UECM_Registration message in step 4. For example, the UDM 75 sends the Nudm_UECM_Registration response message after updating the DB. For example, the UDM 75 may send the Nudm_UECM_Registration response message in a case where the UDM 75 receives, from the AMF 7001, the Nudm_UECM_Registration message or any existing message between UDM and AMF or a new message between UDM and AMF.

The Data from UDM may be expressed as Data from UDM parameter.

In order to generate the Ciphered private container including the Data from UDM, the UDM 75 sends an Nausf_SoRProtection message to the AUSF 74 including SoR header and Steering Information. The Steering Information includes Data from UDM with clear texts. For example, the Data from UDM with clear texts may mean deciphered or unencrypted Data from UDM. After the AUSF 74 performs the ciphering for the Data from UDM as the Steering Information, the UDM 75 receives an Nausf_SoRProtection response message from the AUSF 74 including the ciphered Data from UDM. For details of parameters in the Data from UDM, it may refer to the bullets in the step 5 of the First example of the First Aspect. For example, the Dara from UDM may include the Slice Availability information of the First example of the First Aspect.

It may refer to the Sixth example of the First Aspect for details of the Data from UDM.

Step 6. The AMF 7001 sends a Registration Accept message to the UE 3 including a Ciphered private container which includes the Data from UDM received in the Nudm_UECM_Registration response message in step 5 from the UDM 75. For example, the Data from UDM may be the ciphered Data from UDM. In case that the AMF 7001 does not receive the Slice Availability feature support parameter from the UE 3 in the Registration Request message in step 3, the AMF 7001 does not include the Ciphered private container in the Registration Accept message. The Registration Accept message may include at least one of Allowed NSSAI and Rejected NSSAI.

For example, the AMF 7001 may send the Registration Accept message in a case where the AMF 7001 receives, from the UDM 75, the Nudm_UECM_Registration response message or any existing message between UDM and AMF or a new message between UDM and AMF.

Step 7. Upon reception of the Registration Accept message from the AMF 7001, the UE 3 sends a Registration Complete message to the AMF 7001 including the Ciphered private container which includes the Data from UE. The UE 3 ciphers the Data from UE using the K_{ausf} that is held in the UE 3. The Data from UE includes Rejected NSSAI, Location, and Tuned FB. For details of parameters in the Data from UE, it may refer to the bullets in the step 7 of the First example of the First Aspect. For example, the UE 3 ciphers the Data from UE including Rejected NSSAI, Location, and Tuned FB, and sends the Registration Complete message including the ciphered Data from UE.

Step 8. Upon reception of the Registration Complete message from the UE 3, the AMF 7001 sends an Nudm_UECM_Update message to the UDM 75 including the Ciphered private container which includes the Data from UE. The Data from UE included in the Nudm_UECM_Update message may be same as the one received in step 7.

Step 9. Upon reception of the Nudm_UECM_Update message from the AMF 7001, the UDM 75 sends an Nausf_SoRDeciphering message to the AUSF 74 including SoR header and Ciphered Information asking the associated AUSF 74 for deciphering the Ciphered information. The Ciphered Information includes the ciphered Data from UE. After the AUSF 74 performs the deciphering for the Data from UE as the Ciphered Information, the UDM 75 receives an Nausf_SoRDeciphering response message from the AUSF 74 including the Data from UE with clear texts. For example, the Data from UE with clear texts may mean deciphered or unencrypted Data from UE.

Based on information received in step 8, the UDM 75 updates the DB related to supported network slice information in VPLMN(s). For example, the UDM 75 may perform same process(es) in the step 9 of the First example of the First Aspect.

It may refer to the Third example of the First Aspect for details of interworking between the UDM 75 and the AUSF 74.

Step 10. This step is the same as the step 10 in the First example of the First Aspect.

Step 11. The UE 3 deciphers the Ciphered private container which includes the Data from UDM received in the Registration Accept message in Step 6 using K_{ausf} in the UE 3, and obtains the Slice Availability information in clear texts. For example, the Slice Availability information in clear texts may mean deciphered or unencrypted Slice Availability information. The UE 3 performs process(es) as described in the step 11 in the First example of the First Aspect.

Step 12. This step is the same as the step 12 in the First example of the First Aspect.

Step 13. This step is the same as the step 13 in the First example of the First Aspect.

Step 14. This step is the same as the step 14 in the First example of the First Aspect.

### Variant 1 of Second Example of the First Aspect

Instead of the Nudm_UECM_Registration message in step 4, the AMF 7001 sends the Ciphered private container which includes the Data from UE to the UDM 75 by using an Nudm_SDM_Get message or any existing message between the AMF and the UDM or a new message between AMF and the UDM.

### Variant 2 of Second Example of the First Aspect

Instead of the Nudm_UECM_Registration response message in step 5, the UDM 75 sends the Ciphered private container which includes the Data from UDM to the AMF 7001 by using an Nudm_SDM_Get response message or any existing message between the AMF and the UDM or a new message between AMF and the UDM.

### Third Example of the First Aspect

Third example of the First Aspect discloses a method that enables data transfer securely from a UE 3 to a UDM 75. Third example of the First Aspect may be used by other examples of the First Aspect. For example, process(es) in Third example of the First Aspect may be used in process(es) where the UE 3 and the UDM 75 communicate ciphered Data. For example, the ciphered Data may be Data from UE or Data from UDM.

The detailed processes of the Third example of the First Aspect are as described below.

Step 1. It is assumed that the UE 3 and the AUSF 74 share the common K_{ausf} that may be generated in the Authentication procedure.

Step 2. When the UE 3 has data to be securely transferred to the UDM 75, the UE 3 ciphers data using the K_{ausf} and Counter_{SoR}. If the UE 3 needs an acknowledgement from the UDM 75 for successful transfer, the UE 3 generates SoR-XMAC-I_{UAUSF} and stores the SoR-XMAC-I_{UAUSF} in the UE 3.

Step 3. The UE 3 sends a message to the UDM 75 that includes an SoR transparent container. The SoR transparent container may include SoR header, SoR-MAC-I_{UAUSF}, Counter_{SoR} and Ciphered data. The following bullets explain a detail of each parameters.
SoR header indicates a format of the SoR transparent container.
SOR-MAC-I_{UAUSF} is used by the AUSF 74 for verification of the received ciphered data by comparing with the SOR-XMAC-I_{UAUSF} generated by the AUSF 74.
Counter_{SoR} is used by the AUSF 74 when the AUSF 74 generates SoR-MAC-I_{UAUSF}. The Counter_{SoR} is used as freshness input into SoR-MAC-I_{UAUSF} derivation.
Ciphered data is data that the UE 3 transfers to the UDM 75.

In one example, the UE 3 sends a NAS message including the SoR transparent container to the AMF 7001, and the AMF 7001 forwards the SoR transparent container to the UDM 75.

Step 4. Upon reception of the SoR transparent container from the UE 3, the UDM 75 generates an Nausf_SoRDeciphering message including Requester ID, SUPI, Service name, Ciphered Data, SoR-MAC-I_{UAUSF}, Counter_{SoR}, ACK Indication parameters. The following bullets explain a detail of each parameters.
Requester ID indicates identifier of a request for the Nausf_SoRDeciphering service.
SUPI is a user identity for the UE 3.
Service name indicates that the UDM 75 requests to decipher the ciphered data sent from the UE 3.
ACK Indication is an indication that the UDM 75 is required to send an acknowledgement to the UE 3. If this indication is indicated, the AUSF 74 generates the SoR-XMAC-I_{UAUSF}.
Ciphered Data, SoR-MAC-I_{UAUSF} and Counter_{SoR} may be the same as the ones in step 3.

In one example, the Nausf_SoRDeciphering service may have different service name, for example, such as Nausf_SoRUnprotect service, Nausf_SoUnlock service or Nausf_SoRProtection service with unique Service name. For example, the unique Service name may be Deciphering.

In another example, the Nausf_SoRDeciphering message may have different message name, for example, such as an Nausf_SoRUnprotect message, an Nausf_SoUnlock message or an Nausf_SoRProtection message with unique Service name. For example, the unique Service name may be Deciphering.

Step 5. Upon reception of the Nausf_SoRDeciphering message, the AUSF 74 generates or calculates the SoR-XMAC-I_{UAUSF} and verifies whether it matches the SoR-MAC-I_{UAUSF} value received in the Nausf_SoRDeciphering message. Once the SoR-XMAC-I_{UAUSF} verification is successful, the AUSF 74 deciphers the received Ciphered Data. The successful SOR-XMAC-I_{UAUSF} verification may mean the generated (or calculated) SoR-XMAC-I_{UAUSF} matches the SOR-MAC-I_{UAUSF} value received in the Nausf_SoRDeciphering message. If the ACK Indication is indicated, the AUSF 74 generates SoR-XMAC-I_{UAUSF}.

Step 6. The AUSF 74 sends an Nausf_SoRDeciphering response message to the UDM 75 including Data with clear text and optionally the SOR-XMAC-I_{UAUSF}. The Data included in the Nausf_SoRDeciphering response message may be a date which is deciphered by the AUSF 74 in step 5.

In one example, the Nausf_SoRDeciphering response message may have different message name, for example, such as an Nausf_SoRUnprotect response message, an Nausf_SoUnlock response message or an Nausf_SoRProtection response message with unique Service name. For example, the unique Service name may be Deciphering.

Step 7. Upon reception of the Nausf_SoRDeciphering response message from the AUSF 74, the UDM 75 uses the Data in clear text for internal process in the UDM 75.

In case that the acknowledgement is indicated from the UE 3 in step 3, the UDM 75 sends a message to the UE 3 including the SOR-XMAC-I_{UAUSF}.

In one example, the UDM 75 sends a message to the AMF 7001 including the SOR-XMAC-I_{UAUSF} and the AMF 7001 forwards the SOR-XMAC-I_{UAUSF} to the UE 3 using a NAS message.

Step 8. Upon reception of the SoR-XMAC-I_{UAUSF} from the UDM 75 in step 7, the UE 3 compares the received SoR-XMAC-I_{UAUSF} with the SOR-XMAC-I_{UAUSF} that the UE 3 stored temporarily in step 2 for making sure that the data transfer is successfully completed with the UDM 75. For example, in a case where the UE 3 determines that the received SoR-XMAC-I_{UAUSF} is same to the SOR-XMAC-I_{UAUSF} that the UE 3 stored temporarily in step 2, the UE 3 determines that the data transfer is successfully completed with the UDM 75.

### Variant 1 of Third Example of the First Aspect

In Third example of the First Aspect, it discloses that the Counter_{SoR} is commonly used for two procedures such as the secure data transfer from the UDM to UE and the secure data transfer from the UE to the UDM. The variant 1 discloses that the secure data transfer from the UE to the UDM may have own counter value Counter_{SoR}. In this case, all the Counter_{SoR} appear in the Third example of the First Aspect are replaced with Counter_{SoR}. The usage of Counter_{SoR} is the same as the usage of Counter_{SoR}.

### Variant 2 of Third Example of the First Aspect

In Third example of the First Aspect, it discloses that the SOR-XMAC-I_{UAUSF} is uniquely used for the secure data transfer from the UE to the UDM. The variant 2 discloses that the secure data transfer from the UE to the UDM may use the existing SoR-XMAC-I_{AUSF} as defined in NPL 8.

In this case, all the SoR-XMAC-I_{UAUSF} appear in the Third example of the First Aspect are replaced with SoR-XMAC-I_{AUSF}. The usage of SOR-XMAC-I_{AUSF} is the same as the usage of SOR-XMAC-I_{UAUSF}.

### Fourth Example of the First Aspect

Fourth example of the First Aspect discloses a method that enables secure data exchange between a UE 3 and a UDM 75 using a Ciphered private container.

When the HPLMN operator needs to provision prioritization information of the VPLMN(s) to the UE 3 while the UE 3 is roaming, the UDM 75 provides the prioritization information of the VPLMN(s) to the UE 3 using the Fourth example of the First Aspect.

Similarly, when the UE 3 needs to provision VPLMN related information to the UDM 75, the UE 3 provides the VPLMN information to the UDM 75 using the Fourth example of the First Aspect.

The detailed processes of the Fourth example of the First Aspect are as described below.

Step 1. It is assumed that a capability negotiation for Private container handling has successfully performed among the UE 3, AMF 7001 and the UDM 75.

For example, the capability negotiation is performed in a Registration procedure.
The UE 3 sends a Registration Request message to the AMF 7001 including a Private container handling capability parameter. The Private container handling capability parameter may mean the UE 3 supports a Private container handling feature.
The AMF 7001 forwards this parameter to the UDM 75 in an Nudm_UECM_Registration message, an Nudm_SDM_Get message or other existing message. In case that the AMF 7001 does not support the Private container handling, the AMF 7001 does not forward this parameter to an the UDM 75 in Nudm_UECM_Registration message, an Nudm_SDM_Get message or other existing message and the Private container handling negotiation fails.
The UDM 75 sends an Nudm_UECM_Registration response message, an Nudm_SDM_Get response message or other existing message including a Private container handling capability parameter. The Private container handling capability parameter may mean whether the UDM 75 or HPLMN supports the Private container handling feature or not. For example, the Private container handling capability parameter may mean the UDM 75 or HPLMN supports the Private container handling feature. For example, the Private container handling capability parameter may mean the UDM 75 or HPLMN does not support the Private container handling feature. For example, include, in the the UDM 75 may Nudm_UECM_Registration response message, the Nudm_SDM_Get response message or other existing message, the Private container handling capability parameter in a case where the UDM 75 receives the Nudm_UECM_Registration message including the Private container handling capability parameter from the UE 3. For example, the UDM 75 may include, in the Nudm_UECM_Registration response message, the Nudm_SDM_Get response message or other existing message, the Private container handling capability parameter in a case where the Private container handling capability parameter means the UDM 75 or HPLMN supports the Private container handling feature.
The AMF 7001 forwards this parameter to the UE 3 in a Registration Accept message. By performing these processes between the UE 3 and the UDM 75, the capability negotiation for Private container handling has successfully performed. If the UE 3 receives from UDM 75 the Private container handling capability parameter indicating the UDM 75 or HPLMN supports the Private container handling feature, it may mean the capability negotiation for Private container handling has successfully performed. If the UE 3 receives from UDM 75 the Private container handling capability parameter indicating the UDM 75 or HPLMN does not support the Private container handling feature or the UE 3 does not receive from UDM 75 the Private container handling capability parameter, it may mean the capability negotiation for Private container handling has failed. The UE 3 may perform a process in step 2 in a case where the capability negotiation for Private container handling has successfully performed.

In addition, the UDM 75 has an associated AUSF 74 for the UE 3, and the UE 3 and the AUSF 74 share the common K_{ausf}.

Step 2. If the UE 3 needs to send VPLMN information to the UDM 75 and the UE 3 is aware that the UDM 75 supports Private container handling, the UE 3 generates a Ciphered private container which includes Data from UE using the K_{ausf} that is held in the UE 3. For example, a case where the UE 3 needs to send VPLMN information to the UDM 75 and the UE 3 is aware that the UDM 75 supports Private container handling may mean a case where the UE 3 needs to send the VPLMN information to the UDM 75 and the capability negotiation for Private container handling has successfully performed in step 1. The VPLMN information may include Provided NSSAI, Interested NSSAI, Location, Tuned FB, UE Radio Capability and Slice Availability feature support parameter. The Data from UE may include Provided NSSAI, Interested NSSAI, Location, Tuned FB, UE Radio Capability and Slice Availability feature support parameter. For details of parameters in the VPLMN information or in the Data from UE, it may refer to the bullets in the step 3 of the First example of the First Aspect. For example, the UE 3 ciphers the Data from UE including Provided NSSAI, Interested NSSAI, Location, Tuned FB, UE Radio Capability, Available PLMNs list and Slice Availability feature support parameter, and includes the ciphered Data from UE in the Ciphered private container. For example, in a case where the UE 3 performs step 1 and at least one of step 2-1 and step 2-2 of the First example of the First Aspect and the capability negotiation for Private container handling has successfully performed, the UE 3 generates the Ciphered private container.

It may refer to the Third example of the First Aspect for details for ciphering of the Data from UE.

Step 3. The UE 3 sends a UL NAS transport message to the AMF 7001 including the Ciphered private container which includes the Data from UE. For example, the Data from UE may mean the ciphered Data from UE.

It may refer to the Sixth example of the First Aspect for details of the Data from UE.

Step 4. Upon reception of the UL NAS transport message from the UE 3, the AMF 7001 sends an Nudm_UECM_Registration message to the UDM 75 including the Ciphered private container which includes the Data from UE. For example, the Data from UE may mean the ciphered Data from UE.

Step 5. Upon reception of the Nudm_UECM_Update message from the AMF 7001, the UDM 75 sends an Nausf_SoRDeciphering message to the AUSF 74 including SoR header and Ciphered Information asking the AUSF 74 for deciphering the Ciphered information. The Ciphered Information includes the ciphered Data from UE. After the AUSF 74 performs the deciphering for the Data from UE as the Ciphered Information, the UDM 75 receives an Nausf_SoRDeciphering response message from the AUSF 74 including the Data from UE with clear texts. For example, the Data from UE with clear texts may mean deciphered or unencrypted Data from UE.

Based on information received in step 4, the UDM 75 updates the DB related to supported network slice information in VPLMN(s). For example, based on the received deciphered Data from UE, the UDM 75 may update the DB related to supported network slice information in VPLMN(s). In one example the UDM 75 may take an action defined in the step 5 of First example of the First Aspect. In one example the UDM 75 may take an action defined in the step 9 of First example of the First Aspect.

It may refer to the Third example of the First Aspect for details of interworking between the UDM 75 and the AUSF 74.

Step 6. If the UDM 75 needs to send the prioritization information of the VPLMN(s) to the UE 3 and the UDM 75 is aware that the UE 3 supports Private container handling, the UDM 75 sends an Nudm_UECM_Update response message to the AMF 7001 including a Ciphered private container which includes Data from UDM. For example, the prioritization information of the VPLMN(s) may be the Slice Availability information. For example, the UDM 75 may be aware that the UE 3 supports Private container handling by the capability negotiation for Private container handling being successfully performed in step 1. For example, the UDM 75 may send the Nudm_UECM_Update response message in a case where the capability negotiation for Private container handling has successfully performed in step 1 and the UDM 75 receives, from the AMF 7001, the Nudm_UECM_Update message or any existing message between UDM and AMF or a new message between UDM and AMF. For example, the UDM 75 may send the Nudm_UECM_Update response message in a case where the UDM 75 receives, from the AMF 7001, the Nudm_UECM_Update message or any existing message between UDM and AMF or a new message between UDM and AMF. For example, the UDM 75 may send the Nudm_UECM_Update response message in a case where the UDM 75 updates the DB related to supported network slice information in VPLMN(s) in step 5.

In order to generate the Ciphered private container which includes Data from UDM, the UDM 75 sends an Nausf_SoRProtection message to the AUSF 74 including SoR header and Steering Information. The Steering Information includes the Data from UDM with clear texts. For example, the Data from UDM with clear texts may mean deciphered or unencrypted Data from UDM. After the AUSF 74 performs the ciphering for the Data from UDM as the Steering Information, the UDM 75 receives an Nausf_SoRProtection response message from the AUSF 74 including the ciphered Data from UDM. The Data from UDM includes the Slice Availability information. For examples of the Slice Availability information in the Data from UDM, it may refer to the bullets in the step 5 of the First example of the First Aspect. For example, the UDM 75 may generate the Slice Availability information in the same manner as the step 5 of the First example of the First Aspect.

It may refer to the Sixth example of the First Aspect for details of the Data from UDM.

Step 7. The AMF 7001 sends a DL NAS transport message to the UE 3 including the Ciphered private container which includes the Data from UDM that is received in the Nudm_UECM Update response message in step 6 from the UDM 75. For example, the Data from UDM may mean the ciphered Data from UDM. For example, the AMF 7001 may send the DL NAS transport message in a case where the AMF 7001 receives, from the UDM 75, the Nudm_UECM_Update response message or any existing message between UDM and AMF or a new message between UDM and AMF.

Step 8. Upon reception of the DL NAS transport message from the AMF 7001 in step 7, the UE 3 deciphers the Ciphered private container which includes the Data from UDM that is received in the DL NAS transport message using K_{ausf} in the UE 3, and obtains the Data from UDM in clear texts. For example, the Data from UDM may mean the ciphered Data from UDM. For example, the Data from UDM in clear texts may mean deciphered or unencrypted Data from UDM. The UE 3 performs process(es) as described in the step 11 in the First example of the First Aspect. After the UE 3 deciphers the Ciphered private container and obtains the Data from UDM in clear texts, the UE 3 may perform process(es) as described in the step 11 in the First example of the First Aspect.

### Fifth Example of the First Aspect

Fifth example of the First Aspect discloses a method that enables secure data exchange between a UE 3 and a UDM 75 using a Ciphered private container.

When the HPLMN operator needs to provision prioritization information of the VPLMN(s) to the UE 3 while the UE 3 is roaming, the UDM 75 provides the prioritization information of the VPLMN(s) to the UE 3 using the Fifth example of the First Aspect.

Similarly, when the UE 3 needs to provision VPLMN related information to the UDM 75, the UE 3 provides the VPLMN information to the UDM 75 using the Fifth example of the First Aspect.

The detailed processes of the Fifth example of the First Aspect are as described below.

Step 1. This step is the same as the step 1 in the Fourth example of the First Aspect.

Step 2 and Step 3. If the UDM 75 needs to send the prioritization information of the VPLMN(s) to the UE 3 and the UDM 75 is aware that the UE 3 supports Private container handling, the UDM 75 sends an Nudm_SMD Notification message to the AMF 7001 including a Ciphered private container which includes Data from UDM. For example, the prioritization information of the VPLMN(s) may be the Slice Availability information. For example, the UDM 75 may be aware that the UE 3 supports Private container handling by the capability negotiation for Private container handling being successfully performed in step 1.

In order to generate the Ciphered private container which includes Data from UDM, the UDM 75 sends an Nausf_SoRProtection message to the AUSF 74 including SoR header and Steering Information. The Steering Information includes Data from UDM with clear texts. After the AUSF 74 performs the ciphering for the Data from UDM as the Steering Information, the UDM 75 receives an Nausf_SoRProtection response message from the associated AUSF 74 including the ciphered Data from UDM. The Data from UDM includes the Slice Availability information. For examples of the Slice Availability information in the Data from UDM, it may refer to the bullets in the step 5 of the First example of the First Aspect. For example, the UDM 75 may generate the Slice Availability information in the same manner as the step 5 of the First example of the First Aspect. For example, the UDM 75 may generate the Slice Availability information based on information included in the DB as described in the First example of the First Aspect.

For example, the UDM 75 may generate the Prioritized list of VPLMN(s) with supported S-NSSAI(s) together with FB information with location for entire coverage of the VPLMN as the Slice Availability information based on the entries in the list of roaming partners per location. For example, the list of roaming partners may be the list of VPLMN(s).

For example, the UDM 75 may generate the Prioritized list of VPLMN(s) with supported S-NSSAI(s) together with FB information with location for entire coverage of each VPLMN included in the list of roaming partners. For example, the list of roaming partners may be the list of VPLMN(s).

For example, the UDM 75 may generate the Prioritized list of VPLMN(s) with supported S-NSSAI(s) based on the subscribed NSSAI as the Slice Availability information, on the basis of the subscribed NSSAI in the UDM 75. For example, in a case where the subscribed NSSAI for the UE 3 includes S-NSSAI 1, S-NSSAI 2, S-NSSAI 3 and S-NSSAI 4, the UDM 75 may generate the Prioritized list of VPLMN(s) that supports S-NSSAI 1, S-NSSAI 2, S-NSSAI 3 and S-NSSAI 4.

For example, the UDM 75 may determine that the UDM 75 needs to send the prioritization information of the VPLMN(s) to the UE 3 in a case where the capability negotiation for Private container handling has successfully performed. For example, the prioritization information of the VPLMN(s) may be the Slice Availability information. The UDM 75 may send the Nudm_SMD Notification message to the AMF 7001 including the Ciphered private container.

For example, the UDM 75 may determine that the UDM 75 needs to send the prioritization information of the VPLMN(s) to the UE 3 in a case where contents of the DB in the UDM 75 is updated. For example, the prioritization information of the VPLMN(s) may be the Slice Availability information. The UDM 75 may send the Nudm_SMD Notification message to the AMF 7001 including the Ciphered private container.

For example, the UDM 75 may determine that the UDM 75 needs to send the prioritization information of the VPLMN(s) to the UE 3 in a case where contents of the DB in the UDM 75 is updated. For example, the prioritization information of the VPLMN(s) may be the Slice Availability information. In a case where the capability negotiation for Private container handling has successfully performed, the UDM 75 may send the Nudm_SMD Notification message to the AMF 7001 including the Ciphered private container.

For example, the UDM 75 may send the Nudm_SMD Notification message to the AMF 7001 including the Ciphered private container periodically.

For example, the UDM 75 may send the Nudm_SMD Notification message to the AMF 7001 including the Ciphered private container in a case where the UDM 75 is triggered to send the Nudm_SMD Notification message based on local configuration in the UDM 75 or operator's policy.

It may refer to the Sixth example of the First Aspect for details of the Data from UDM.

Step 4. The AMF 7001 sends a DL NAS transport message to the UE 3 including the Ciphered private container which includes the Data from UDM that is received in the Nudm_SMD Notification message in step 3 from the UDM 75. For example, the Data from UDM may be the ciphered Data from UDM. For example, the AMF 7001 may send the DL NAS transport message in a case where the AMF 7001 receives, from the UDM 75, the Nudm_SMD Notification message or any existing message between UDM and AMF or a new message between UDM and AMF.

Step 5. If the UE 3 needs to send the VPLMN information to the UDM 75 and the UE 3 is aware that the UDM 75 supports Private container handling, the UE 3 generates a Ciphered private container which includes Data from UE using the K_{ausf} that is held in the UE 3. For example, the UE 3 may be aware that the UDM 75 supports Private container handling by the capability negotiation for Private container handling being successfully performed in step 1. The VPLMN information may include Provided NSSAI, Interested NSSAI, Location, Tuned FB, UE Radio Capability and Slice Availability feature support parameter. The Data from UE may include Provided NSSAI, Interested NSSAI, Location, Tuned FB, UE Radio Capability and Slice Availability feature support parameter. For details of parameters in the VPLMN information or in the Data from UE, it may refer to the bullets in the step 3 of the First example of the First Aspect. For example, the UE 3 ciphers the Data from UE including Provided NSSAI, Interested NSSAI, Location, Tuned FB, UE Radio Capability and Slice Availability feature support parameter, and includes the ciphered Data from UE in the Ciphered private container. For example, in a case where the UE 3 performs step 1 and at least one of step 2-1 and step 2-2 of the First example of the First Aspect and the capability negotiation for Private container handling has successfully performed, the UE 3 generates the Ciphered private container.

It may refer to the Sixth example of the First Aspect for details of Data from UE.

It may refer to the Third example of the First Aspect for details for ciphering of the Data from UE.

The UE 3 sends a UL NAS transport message to the AMF 7001 including the Ciphered private container which includes the Data from UE. For example, the Data from UE may be the ciphered Data from UE. For example, the UE 3 may generate the Ciphered private container and send the UL NAS transport message in a case where the capability negotiation for Private container handling has successfully performed in step 1 and the UE 3 receives the DL NAS transport message. For example, the UE 3 may generate the Ciphered private container, and send the UL NAS transport message in a case where the UE 3 receives the DL NAS transport message.

Step 6. Upon reception of the UL NAS transport message from the UE 3, the AMF 7001 sends an Nudm_UECM_Update message to the UDM 75 including the Ciphered private container which includes the Data from UE. For example, the Data from UE may be the ciphered Data from UE.

Step 7. Upon reception of the Nudm_UECM_Update message from the AMF 7001, the UDM 75 sends an Nausf_SoRDeciphering message to the AUSF 74 including SoR header and Ciphered Information asking the AUSF 74 for deciphering the Ciphered information. The Ciphered Information includes the ciphered Data from UE. After the AUSF 74 performs the deciphering for the Data from UE as the Ciphered Information, the UDM 75 receives an Nausf_SoRDeciphering response message from the AUSF 74 including the Data from UE with clear texts. For example, the Data from UE with clear texts may mean deciphered or unencrypted Data from UE.

Based on information received in step 6, the UDM 75 updates the DB related to supported network slice information in VPLMN(s). For example, based on the deciphered Data from UE, the UDM 75 may update the DB related to supported network slice information in VPLMN(s). In one example the UDM 75 may take an action defined in the step 5 of First example of the First Aspect. In one example the UDM 75 may take an action defined in the step 9 of First example of the First Aspect.

It may refer to the Third example of the First Aspect for details of interworking between the UDM 75 and the AUSF 74.

Step 8. Upon reception of the DL NAS transport message from the AMF 7001 in step 4, the UE 3 deciphers the Ciphered private container which includes the Data from UDM that is received in the DL NAS transport message using K_{ausf} in the UE 3, and obtains the Data from UDM in clear texts. For example, the Data from UDM in clear texts may mean deciphered or unencrypted Data from UDM. For example, the Data from UDM may mean the ciphered Data from UDM. The UE 3 performs process(es) as described in the step 11 in the First example of the First Aspect.

### Variant 1 of Fifth Example of the First Aspect

Instead of the DL NAS transport message in step 4, the AMF 7001 sends the Ciphered private container which includes the Data from UDM to the UE 3 by using a CONFIGURATION UPDATE COMMAND message.

### Variant 2 of Fifth Example of the First Aspect

Instead of the UL NAS transport message in step 5, the UE 3 sends the Ciphered private container which includes the Data from UE to the AMF 7001 by using a CONFIGURATION UPDATE COMMAND COMPLETE message.

### Sixth Example of the First Aspect

Sixth example of the First Aspect discloses examples of the Data from UDM and the Data from UE as described in some examples of the First Aspect.

The Table 1 illustrates some examples of the Data from UDM. For example, the Data from UDM may include at least one of the parameters listed in the Table 1.

TABLE 1
Examples of the Data from UDM

| Data from UDM | Meaning |
|---|---|
| Slice Availability information as | The Slice Availability |
| described in the step 5 of First | information indicates S-NSSA [symbol] ( [symbol] ) |
| example of the First Aspect. | that are available to the UE at |
| | the location where the UE is |
| | located. |
| Protocol configuration option from | Protocol configuration options |
| the UDM. | that the UDM wishes to provision |
| | to the UE to configure. |

[symbol]

indicates data missing or illegible when filed

The Table 2 illustrates some examples of the Data from UE. For example, the Data from UE may include at least one of the parameters listed in the Table 2. VPLMN ID may indicate identity of a VPLMN where the UE 3 is registered or registering. “S-NSSAIx” may mean arbitrary S-NSSAI or any one of S-NSSAI(s).

TABLE 2
Examples of the Data from UE

| Data from UE | Meaning |
|---|---|
| VPLMN ID | VPLMN ID where the UE is |
| | registered or registering. |
| UE location | Refer to the First example |
| | of the First Aspect. |
| Tuned FB | Refer to the First example |
| | of the First Aspect. |
| Requested NSSAI | Refer to the First example |
| | of the First Aspect. |
| Interested NSSAI | Refer to the First example |
| | of the First Aspect. |
| Available NSSAI | Refer to the First example |
| | of the First Aspect. |
| Rejected NSSAI | Refer to the First example |
| | of the First Aspect. |
| Any combination of parameters | Refer to the First example |
| listed above in this table | of the First Aspect. |
| Information in SIM and ME. For | UE related information. |
| example, PEI (IMEISV), Network | |
| Slice Simultaneous Registration | |
| Group (NSSRG) status UE Radio | |
| Capability | |
| Quot [symbol] availability VPLMN for | Whether S-NSSA [symbol] is rejected |
| Network Slice Admission Control | due to for Network Slice |
| | Admission Control in VPLMN. |

[symbol]

indicates data missing or illegible when filed

### <Second Aspect>

In order to make an HPLMN operator possible to provide accurate prioritization information of the VPLMN(s) to a UE while the UE is roaming, the HPLMN operator needs to maintain the latest information. For example, the HPLMN operator may have Database (DB) of the UE configuration as well as network status in a location where the UE is roaming.

The DB in the HPLMN is basically managed by Operation and Maintenance (O&M) process. However, it is very difficult to maintain the latest network configuration in roaming partner networks as the roaming partners span to all over the world.

Second Aspect discloses a dynamic DB update mechanism that enables the HPLMN operator to securely obtain information on the UE configuration and a network status at a location which the UE is roaming to.

The Second Aspect can solve the problem that there is no clear mechanism defined in 3GPP specifications how the requirement in NPL 2 can be realized.

### First Example of the Second Aspect

First example of the Second Aspect discloses a method that a UDM 75 queries information on a UE 3's configuration and a network status at a location where a UE 3 is roaming to.

The detailed processes of the First example of the Second Aspect are as described below.

Step 1. This step is the same as the step 1 in the Fourth example of the First Aspect.

Step 2 and Step 3. If the UDM 75 needs to obtain at least one of a UE 3's configuration and a network status at a location where the UE 3 is located and the UDM 75 is aware that the UE 3 supports Private container handling, the UDM 75 sends an Nudm_SMD Notification message to the AMF 7001 including Ciphered private container which includes Request from UDM. For example, the UDM 75 is aware that the UE 3 supports Private container handling in a case where the capability negotiation for Private container handling has successfully performed in step 1.

In order to generate the Ciphered private container which includes Request from UDM, the UDM 75 sends an Nausf_SoRProtection message to the AUSF 74 including SoR header and Steering Information. The Steering Information includes the Request from UDM with clear texts. For example, the Request from UDM with clear texts may mean deciphered or unencrypted Request from UDM. After the AUSF 74 performs the ciphering for the Request from UDM as the Steering Information, the UDM 75 receives an Nausf_SoRProtection response message from the AUSF 74 including the ciphered Request from UDM.

For example, the UDM 75 may determine that the UDM 75 needs to obtain at least one of a UE 3's configuration and a network status at a location where the UE 3 is located in a case where the capability negotiation 1 for Private container handling has successfully performed. The UDM 75 may send the Nudm_SMD Notification message to the AMF 7001 including the Ciphered private container.

For example, the UDM 75 may determine that the UDM 75 needs to obtain at least one of a UE 3's configuration and a network status at a location where the UE 3 is located in a case where contents of the DB in the UDM 75 is updated. The UDM 75 may send the Nudm_SMD Notification message to the AMF 7001 including the Ciphered private container.

For example, the UDM 75 may determine that the UDM 75 needs to obtain at least one of a UE 3's configuration and a network status at a location where the UE 3 is located in a case where contents of the DB in the UDM 75 is updated. In a case where the capability negotiation for Private container handling has successfully performed, the UDM 75 may send the Nudm_SMD Notification message to the AMF 7001 including the Ciphered private container.

For example, the UDM 75 may send the Nudm_SMD Notification message to the AMF 7001 including the Ciphered private container periodically.

For example, the UDM 75 may send the Nudm_SMD Notification message to the AMF 7001 including the Ciphered private container in a case where the UDM 75 is triggered to send the Nudm_SMD Notification message based on local configuration in the UDM 75 or operator's policy.

It may refer to the Second example of the Second Aspect for details of the Request from UDM.

Step 4. The AMF 7001 sends a DL NAS transport message to the UE 3 including the Ciphered private container which includes the Request from UDM that is received in the Nudm_SMD Notification message in step 3 from the UDM 75. For example, the Request from UDM may mean the ciphered Request from UDM. For example, the AMF 7001 sends the DL NAS transport message in a case where the AMF 7001 receives, from the UDM 75, the Nudm_SMD Notification message or any existing message between UDM and AMF or a new message between UDM and AMF.

Step 5. Upon reception of the DL NAS transport message from the AMF 7001 in step 4, the UE 3 deciphers the Ciphered private container which includes the Request from UDM that is received in the DL NAS transport message using K_{ausf} in the UE 3, and obtains the Request from UDM in clear texts. For example, the Request from UDM in clear texts may mean deciphered or unencrypted Request from UDM.

The UE 3 checks the Request form UDM, and collects requested information based on the Request from UDM. The UE 3 may perform at least one of a Registration Management (RM) procedure, a Session Management (SM) procedure, scanning a designated FB and any other action if the UE 3 needs to take actions in order to collect requested information for providing to the UDM 75. The Registration Management (RM) procedure may be a tentative Registration procedure to a designated VPLMN by the UDM 75. It may refer to the Second example of the Second Aspect for details of the requested information.

Step 6. If the UE 3 collects the requested information and the UE 3 is aware that the UDM 75 supports Private container handling, the UE 3 generates the Ciphered private container which includes Data from UE using the K_{ausf} that is held in the UE 3. For example, the UE 3 is aware that the UDM 75 supports Private container handling in a case where the capability negotiation for Private container handling has successfully performed in step 1. For example, the Data from UE may include the requested information.

It may refer to the Sixth example of the First Aspect for details of the Data from UE. It may refer to the Second example of the Second Aspect for details of the Data from UE.

It may refer to the Third example of the First Aspect for details for ciphering of the Data from UE.

Then, the UE 3 sends a UL NAS transport message to the AMF 7001 including the Ciphered private container which includes the Data from UE. For example, the Data from UE may mean ciphered Data from UE.

Step 7. This step is the same as the step 6 in the Fifth example of the First Aspect.

Step 8. This step is the same as the step 7 in the Fifth example of the First Aspect.

The Request from UDM may be expressed as a request to send first information indicating a first network slice which is available in a first network where the UE 3 is located and second information indicating a second network slice which is required by a service or an application activated in the UE 3 and is not available on the first network.

### Variant 1 of First Example of the Second Aspect

Instead of the DL NAS transport message in step 4, the AMF 7001 sends the Ciphered private container which includes the Request from UDM to the UE 3 by using a CONFIGURATION UPDATE COMMAND message.

### Variant 2 of First Example of the Second Aspect

Instead of the UL NAS transport message in step 6, the UE 3 sends the Ciphered private container which includes the Data from UE to the AMF 7001 by using a CONFIGURATION UPDATE COMMAND COMPLETE message.

### Second Example of the Second Aspect

Second example of the Second Aspect discloses examples of the Request from UDM as described in the First example of the Second Aspect.

The Table 3 illustrates some examples of the Request from UDM.

TABLE 3
Examples of the Request from UDM

| Request from UDM | Meaning |
|---|---|
| Request for UE configurations. | Request for UE configuration. |
| Allowed NSSAI [symbol] Configured NSSAI | In this case, the UE can send |
| and Available NSSAI with FB. | the UE configuration to the UDM. |
| Request for UE configuration. | Request for UE configuration [symbol] |
| Network Slice Simultaneous | In this case [symbol] the UE can |
| Registration Group (NSSRG) | send the UE configuration to |
| information that the AMF provided | the UDM. |
| to the UE | |
| Request for UE configurations, | Request for UE configuration [symbol] |
| UE context in both SIM and ME. | In this case [symbol] the UE can send |
| Example [symbol] PEI (IMEISV) | the UE configuration to the UDM. |
| Request for Quote availability. | HPLMN requests to know a Quot [symbol] |
| For example [symbol] whether PDU | status in VPLMN [symbol] UE may |
| session can be established with | tentatively establish a PDU |
| S-NSSA [symbol] | session for a designated S-NSSA [symbol] |
| | to check whether Quot [symbol] for PDU |
| | session is available or not. |
| Request for network status where | HPLMN requests to know an |
| the UE is located. For example [symbol] | availability of S-NSSA [symbol] with |
| whether S-NSSA [symbol] with [symbol] 00 | FB [symbol] UE may tentatively scan |
| MHz FB available? If yes [symbol] provide a | a designated FB to check whether |
| list of VPLMNs. | S-NSSA [symbol] is available or not [symbol] |

[symbol]

indicates data missing or illegible when filed

For example, in a case where the UE 3 receives the Request from UDM, the UE 3 sends the UL NAS transport message to the AMF 7001 including the Data from UE such as at least one of UE configuration, Allowed NSSAI, Configured NSSAI, Available NSSAI, Network Slice Simultaneous Registration Group (NSSRG) information that the AMF provided to the UE 3, a UE context in both SIM and ME, Quota availability and status of the network where the UE 3 locates. For example, the NSSRG information may be provided by the AMF 7001 to the UE 3. For example, the UE context in both SIM and ME may mean PEI (IMEISV). For example, the Quota availability may mean information indicating whether PDU session can be established with S-NSSAIx, or quota status in the VPLMN where the UE 3 locates, or information indicating whether quota for PDU session is available or not. For example, the status of the network where the UE 3 locates may mean information indicating whether S-NSSAIx with 900 MHZ FB is available.

For example, in a case where the UE 3 receives the Request from UDM, the UE 3 sends the UL NAS transport message to the AMF 7001 including the Data from UE such as at least one of parameters listed in the Table 2. “S-NSSAIx” may mean arbitrary S-NSSAI or any one of S-NSSAI(s).

### <Third Aspect>

The Third Aspect discloses a mechanism that enables an HPLMN operator to provide a roaming UE with network slice availability information regarding its roaming partners. For example, the network slice availability information may mean information about the availability of the network slices per VPLMN, per Frequency Band (FB), per RAT and per location. The HPLMN makes use of a Database (DB) in at least one of UDR and UDM with network slice availability information for all roaming partners. Based on this information and the location of the roaming UE, the HPLMN creates a new URSP rule for available network slice selection in roaming and provides the rule to the roaming UE at each registration and re-registration via the URSP rules updates.

The Third Aspect can solve the problem that there is no clear mechanism defined in 3GPP specifications how the requirement in NPL 2 can be realized.

### First Example of the Third Aspect

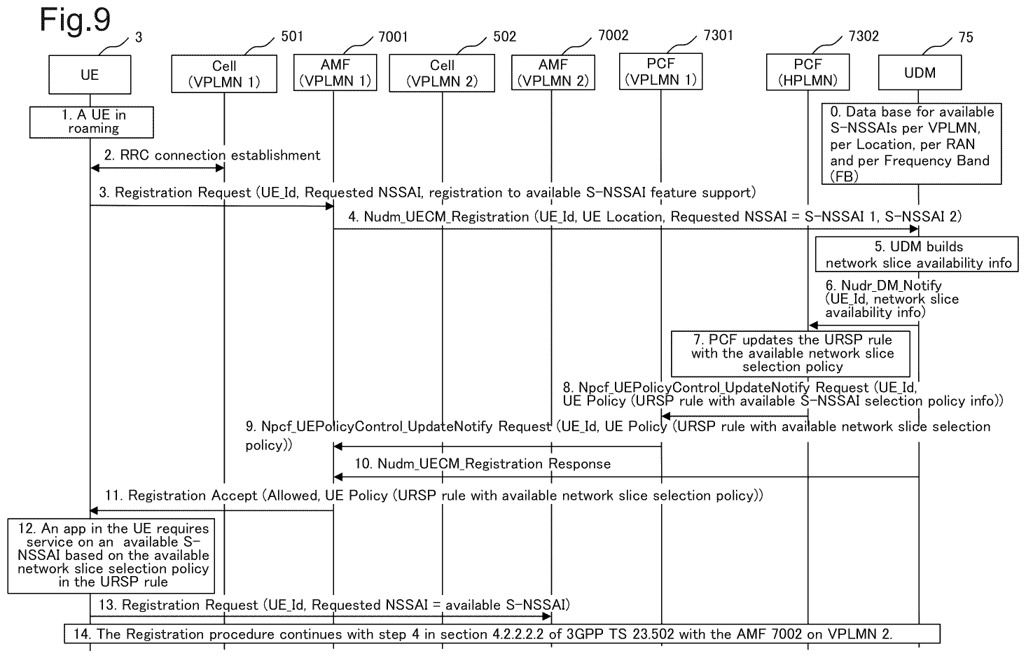

FIG. 9 describes an example for a UE and network behavior and interactions based on the disclosure in the Third Aspect with the following preamble assumptions;
UE 3; Subscribed for network slices S-NSSAI 1, S-NSSAI 2, S-NSSAI 3, S-NSSAI 4
VPLMN 1; A Cell 501 and AMF 7001 support network slices S-NSSAI 1 and S-NSSAI 2.
VPLMN 2; A Cell 502 and AMF 7002 support a network slice S-NSSAI 4.

Step 0. A UDM 75 in an HPLMN holds a Database (DB) with home operator's roaming agreements with its roaming partners from all over the world. The DB may contain a list of roaming partners per location. For example, the list of roaming partners may mean a list of VPLMN(s). For example, the HPLMN has roaming partners, VPLMN 1, VPLMN 2, and VPLMN 3 in Tokyo, Japan listed in priority order. For each VPLMN entry in the DB, the UDM 75 may hold one or more S-NSSAI(s) available in a location together with information about the Frequency Bands (FB) and RAN on which the S-NSSAI are available per each location. The location may be a cell, a list of cells, a TA, a list of TAs, a RA or a list of RAs. For example, in VPLMN 1 in Tokyo, S-NSSAI 1 and S-NSSAI 2 are available with 900 MHz Frequency Band, in VPLMN 2 in Tokyo S-NSSAI 4 is available.

This DB is basically managed by the Operation and Maintenance (O&M) process. In addition to the O&M process, HPLMN operators may use dynamic DB update based on an update mechanism as disclosed by this disclosure. In addition, the UDM 75 has a subscriber data for the UE 3 including S-NSSAI 1, S-NSSAI 2, S-NSSAI 3 and S-NSSAI 4 in the subscribed NSSAI for the UE 3. The list of roaming partners (or the list of VPLMN(s)) may be same to the one in the First example of the First Aspect.

Step 1. The UE 3 moves away from the HPLMN. The UE 3 triggers registration with the HPLMN's preferred roaming partner in the UE's new location, for example with VPLMN 1.

Step 2. The UE 3 first selects a Cell 501 belonging to the VPLMN 1. When selecting a Cell 501 from the VPLMN 1, the UE 3 may consider whether the Cell 501 supports the network slices that the UE 3 requires registration for, for example S-NSSAI 1 and S-NSSAI 2. If Cell 501 supports S-NSSAI 1 and S-NSSAI 2, the UE 3 camps on Cell 501 and the UE 3 establishes RRC connected with Cell 501 belonging to VPLMN 1. For example, the UE 3 may consider whether the Cell 501 supports the network slices that the UE 3 requires registration for based on system information broadcasted in the Cell 501. The system information may be same to the one in step 2-1 of the First example of the First Aspect.

Step 3. The UE 3 sends a Registration Requests message to the AMF 7001 of VPLMN 1. In Registration Request message the UE 3 includes;
UE Id; The UE 3's Identity which may be 5G GUTI, SUPI, SUCI or PEI.
Requested NSSAI; The UE 3 builds the Requested NSSAI based on the Configured NSSAI, Allowed NSSAI and also may take the URSP rule into account and the UE 3 may include in the Requested NSSAI network slice(s) that are supported in the PLMN. For example, the UE 3 may include, in the Requested NSSAI, S-NSSAI 1 and S-NSSAI 2 supported by Cell 501 of VPLMN 1.
Registration to available S-NSSAI feature support indication; If the UE 3 supports the feature of registration to a network slice called e.g. ‘available network slice’ or any other notation for a network slice which is not supported by the PLMN that UE requests registration with, for example VPLMN 1, however the network slice may be supported either by different PLMN in this location, or in different Frequency Band (FB) in this location or supported in different location, the UE 3 includes in the Registration Request message ‘registration to available S-NSSAI feature support’ indication. For example, the UE 3 may include in the Registration Request message ‘registration to available S-NSSAI feature support’ indication in a case where the UE 3 supports S-NSSAI(s) other than S-NSSAI(s) which are available in Cell 501. The ‘registration to available S-NSSAI feature support’ indication may indicate that the UE 3 supports S-NSSAI(s) other than S-NSSAI(s) which are available in Cell 501.

Step 4. The AMF 7001 sends an Nudm_UECM_Registration message to the UDM 75 in order to register the UE 3 with the VPLMN 1. The AMF 7001 includes the following parameters in the Nudm_UECM_Registration message to the UDM 75;
UE Id; The UE 3's Identity which may be 5G GUTI, SUPI, SUCI or PEI.
UE location; If the UE 3 indicated ‘registration to available S-NSSAI feature support’ indication in the Registration Request message, the 7001 AMF includes in the Nudm_UECM_Registration message to the UDM 75 the UE location. For example, the UE location may mean location of the UE 3. The UE location may be a location with a cell, a TA or a RA granularity, e.g., a global cell identity, a list of global cell identities, a TA identity, a list of TAs or RA identity. The UE location may also be NCGI, NCI, TAI, N3IWF user location information, TNGF user location information, TWIF user location information, W-AGF user location information as defined in section 9.3.1.16 of NPL 6.
Requested NSSAI; If the UE 3 indicated ‘registration to available S-NSSAI feature support’ indication in the Registration Request message, the AMF 7001 includes in the Nudm_UECM_Registration message to the UDM 75 the Requested NSSAI received from the UE 3, for example, S-NSSAI 1 and S-NSSAI 2.

For example, the AMF 7001 may send the Nudm_UECM_Registration message in a case where the AMF 7001 receives, from the UE 3, the Registration Request message or any existing message between AMF and UE or a new message between AMF and UE.

Step 5. Based on the UE location and the Requested NSSAI provided by the AMF 7001 and on the UE network slice subscription information and on the network slice availability information in the DB, the UDM 75 builds network slice availability information for network slice(s) that the UE 3 is not registered but the UE 3 may be interested in at some time in the future. For example, the UE location may mean the location of the UE 3. The network slice(s) that the UE 3 is not registered but the UE 3 may be interested in at some time in the future may be called available network slice(s) or any other notation for a network slice(s) with the meaning of network slice(s) for which the UE 3 is not registered as they are not available in the current UE location, or with the meaning of network slice(s) which is not available via the current PLMN, e.g., VPLMN 1, but for which the UE 3 is subscribed for and for which the UE 3 may require access at some stage. For example, the UE 3 is subscribed for S-NSSAI 1, S-NSSAI 2, S-NSSAI 3 and S-NSSAI 4 however, the UE is registering for S-NSSAI 1 and S-NSSAI 2 via VPLMN 1. If the remaining S-NSSAI 3 and S-NSSAI 4 for which the UE also is subscribed to but not registered to, are available in different locations or on different Frequency Bands (FB) or different PLMN(s) as per the information from the DB in the UDM 75, these network slices S-NSSAI 3 and S-NSSAI 4 are considered as available network slice(s). For example, the different PLMN(s) may mean different VPLMN(s) from VPLMN 1. These network slice(s) may also be considered as or called as ‘UE interested network slice(s)’ as the UE 3 is subscribed to these networks slices and at some stage an application in the UE may require service from these network slices. For these so called ‘available network slice(s)’ or ‘UE interested network slice(s)’, the UDM 75 builds network slice availability information, for example, where these network slices are available in terms of location, Frequency Band (FB), RAN type or PLMN. For example, the RAN type may mean RAT type. For example, the UDM 75 builds the network slice availability information indicating that S-NSSAI 3 and S-NSSAI 4 are available in VPLMN 2.

Step 6. The UDM 75 triggers an Nudr_DM_Notify message to a PCF 7302 in the HPLMN in which the UDM 75 includes the network slice availability information, e.g., the network slice availability information for network slices S-NSSAI 3 and S-NSSAI 4, and the UDM 75 also includes the UE 3's identity in UE_Id for which the network slice availability information is applicable for. For example, the UDM 75 may send the Nudr_DM_Notify message in a case where the UDM 75 builds the network slice availability information. For example, the UDM 75 may send the Nudr_DM_Notify message in a case where the UDM 75 receives, from the AMF 7001, the Nudm_UECM_Registration message or any existing message between UDM and AMF or a new message between UDM and AMF.

Step 7. The PCF 7302 uses the network slice availability information from the UDM 75 for the UE 3 to update an URSP rule for the UE 3. The PCF 7302 may create a new entry in the URSP rule for the UE 3 called ‘available network slice selection policy’ or ‘UE interested network slice selection policy’ or any other notation for a policy rule which defines a list of network slices that are available for UE 3 along with their availability details, i.e., at least one of location, Frequency Band (FB), RAN type and PLMN at which these network slices are available. For example, the RAN type may mean RAT type. For example, the PLMN may mean VPLMN. The ‘available network slice selection policy’ or the ‘UE interested network slice selection policy’ or any other notation for a policy rule which defines a list of network slices that are available for UE 3 along with their availability details may be collectively expressed as ‘available network slice selection policy’. For example, the PCF 7302 may create a new entry indicating that S-NSSAI 3 and S-NSSAI 4 are available in VPLMN 2, and add the new entry in the URSP rule for the UE 3. The ‘available network slice selection policy’ may indicate that S-NSSAI 3 and S-NSSAI 4 are available in VPLMN 2.

Step 8. The PCF 7302 triggers an Npcf_UEPolicyControl_UpdateNotify Request message to a PCF 7301 in the VPLMN 1 where the UE 3 is roaming. The PCF 7302 includes the new URSP rule for UE 3 with the ‘available network slice selection policy’ in the Npcf_UEPolicy_Control_UpdateNotify Request message to the PCF 7301, and sends the Npcf_UEPolicyControl_UpdateNotify Request message to the PCF 7301. For example, the PCF 7302 may send the Npcf_UEPolicyControl_UpdateNotify Request message in a case where the PCF 7302 updates the URSP rule for the UE 3 in step 7. For example, the PCF 7302 may send the Npcf_UEPolicyControl_UpdateNotify Request message in a case where the PCF 7302 receives, from the UDM 75, the Nudr_DM_Notify message or any existing message between PCF and UDM or a new message between PCF and UDM.

Step 9. The PCF 7301 triggers an Npcf_UEPolicyControl_UpdateNotify Request message to the AMF 7001 of VPLMN1 in which the PCF 7301 includes the new URSP rule for UE 3 with the ‘available network slice selection policy’. The PCF 7301 sends the Npcf_UEPolicyControl_UpdateNotify Request to the AMF 7001. For example, the PCF 7301 may send the Npcf_UEPolicyControl_UpdateNotify Request message in a case where the PCF 7301 receives, from the PCF 7302, the Npcf_UEPolicyControl_UpdateNotify Request message or any existing message between the PCF 7301 of the visited PLMN and the PCF 7302 of the HPLMN or a new message between the PCF 7301 and the PCF 7302. For example, the visited PLMN may mean VPLMN 1.

Step 10. The UDM 75 returns an Nudm_UECM_Registration Response message to AMF 7001 to confirm UE registration with the UDM 75. For example, the UE registration with the UDM 75 may mean the registration of the UE 3 with the UDM 75. The step 10 may be performed after step 6. For example, the UDM 75 sends the Nudm_UECM_Registration Response message in a case where the UDM 75 sends the Nudr_DM_Notify message in step 6.

Step 11. The AMF 7001 returns a Registration Accept message to the UE 3 in which the AMF 7001 includes the following parameters;
Allowed NSSAI; In the Allowed NSSAI, the AMF 7001 returns S-NSSAI 1 and S-NSSAI 2 for which the UE 3 requested registration for and which are supported by the VPLMN 1.
New URSP rule; If the UE 3 indicated ‘registration to available S-NSSAI feature support’ indication in the Registration Request message, the AMF 7001 includes in the Registration Accept message the updated URSP rule with the latest ‘available network slice selection policy’. For example, the new URSP rule includes ‘available network slice selection policy’ indicating that S-NSSAI 3 and S-NSSAI 4 are available in VPLMN 2.

For example, the AMF 7001 may send the Registration Accept message in a case where the AMF 7001 receives, from the PCF 7301, the Npcf_UEPolicy_Control_UpdateNotify Request message in step 9 or any existing message between PCF and AMF or a new message between PCF and AMF.

For example, the AMF 7001 may send the Registration Accept message in a case where the AMF 7001 receives, from the UDM 75, the Nudm_UECM_Registration Response message or any existing message between UDM and AMF or a new message between UDM and AMF.

For example, the AMF 7001 may send the Registration Accept message in a case where the AMF 7001 receives at least one of the Npcf_UEPolicy_Control_UpdateNotify Request message in step 9 and the Nudm_UECM_Registration Response message.

Step 12. The UE 3 stores the received URSP rule with the updated ‘available network slice selection policy’. When an application in the UE 3 requires a service on one of the available network slices, e.g., S-NSSAI 4, the UE 3 analyses the ‘available network slice selection policy’ within the URSP rule to check if the requested network slice by the application is available in the location of the UE 3 on the same or on a different FB or on a different RAN or on different PLMN. If the requested network slice is available in the UE location, the UE 3 triggers a Registration procedure for S-NSSAI 4 on VPLMN 2. For example, a case that the requested network slice is available in the UE location may mean a case that S-NSSAI 4 is available on VPLMN 2. For example, the UE location may mean location of the UE 3.

Step 13. The UE 3 selects a cell, e.g., Cell 502, of VPLMN 2 and the UE 3 sends a Registration Request message to the AMF 7002 of the VPLMN 2. The UE 3 includes the S-NSSAI 4 in the Requested NSSAI and the UE 3 also includes the ‘registration to available S-NSSAI feature support’ indication in the Registration Request message to AMF 7002 of VPLMN 2.

Step 14. The Registration procedure continues with step 4 in section 4.2.2.2.2 of 3GPP TS 23.502 with the AMF 7002 on VPLMN 2.

The Requested NSSAI may be expressed as first information indicating a first network slice to which the UE 3 requests to register in a first network. The ‘available network slice selection policy’ may be expressed as second information indicating a second network slice which is a network slice to which the UE 3 is subscribed and which is different from the first network slice and which is available in a second network.

### Variant 1 of the First Example of the Third Aspect

In step 4 of FIG. 9 the AMF 7001 may not include the Requested NSSAI in the Nudm_UECM_Registration message to the UDM 75. In this case the UDM 75 builds a network slice availability information based on the DB available in the UDM 75 for all network slices that the UE 3 is subscribed for, including the network slices in the Requested NSSAI. For example, if the UE is subscribed for S-NSSAI 1, S-NSSAI 2, S-NSSAI 3 and S-NSSAI 4, the UDM 75 builds the network slice availability information for S-NSSAI 1, S-NSSAI 2, S-NSSAI 3 and S-NSSAI 4.

### Variant 2 of the First Example of the Third Aspect

In step 11 of FIG. 9 the AMF 7001 may also deliver the new URSP rule with the updated ‘available network slice selection policy’ to the UE 3 via a UE Configuration Update (UCU) message if the UE 3 is in connected mode. For example, instead of the Registration Accept message in step 11, the AMF 7001 may deliver the new URSP rule with the updated ‘available network slice selection policy’ to the UE 3 via a UE Configuration Update (UCU) message if the UE 3 is in connected mode.

If the UE 3 is in idle mode, the AMF 7001 may page the UE 3 in order to bring the UE 3 in connected mode and the AMF 7001 delivers the URSP rule with the updated ‘available network slice selection policy’ to UE 3 via the UE Configuration Update (UCU) message.

### Variant 3 of the First Example of the Third Aspect

In step 7 the PCF 7302 may include a validity restriction while building the ‘available network slice selection policy’ within the URSP rule for UE 3. The validity restriction may be a restriction in terms of time, e.g., the network slice is available only at specific times or the network slice is available for a specific duration of times. The validity restriction may be per a specific network slice within the ‘available network slice selection policy’ or per the ‘available network slice selection policy’ in general. If validity restrictions are set within or for the ‘available network slice selection policy’, the UE 3 takes into account these validity restrictions when a request for available network slice is requested by an application in the UE 3. For example, in a case where the validity restriction indicates that the ‘available network slice selection policy’ is valid until the specific date, the UE 3 checks whether the current date is within the specific date indicated by the validity restriction. For example, if the specific date is January 2022 and the current date is December 2021, the UE 3 may check or determine whether the current date is within the specific date. In a case where the UE 3 determines that the current date is within the specific date indicated by the validity restriction, the UE 3 may perform a registration procedure to S-NSSAI(s) indicated by the ‘available network slice selection policy’.

### <System Overview>

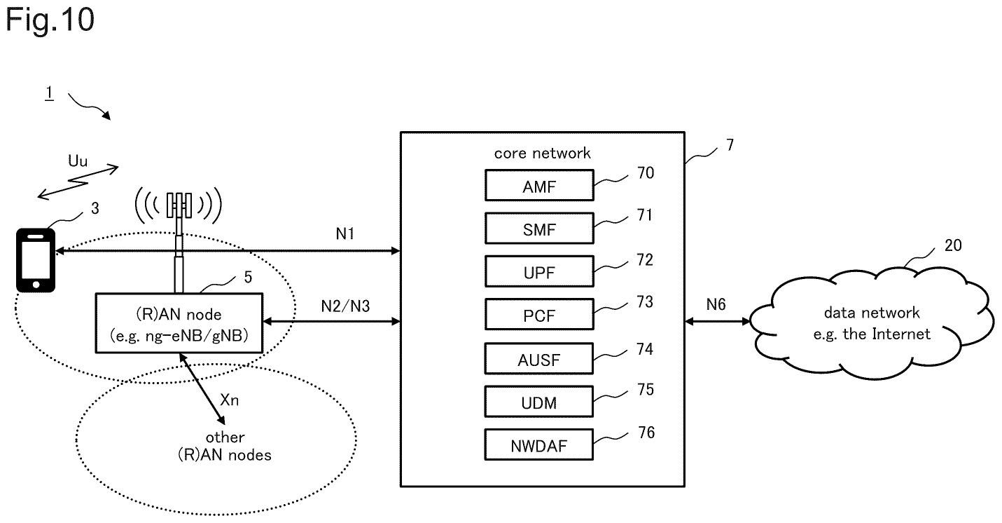

FIG. 10 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message; This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or random Value.
RRC Setup message; This message is sent from the (R)AN node 5 to the UE 3. In addition to the parameters that are disclosed by Aspects in this disclosure, following parameters may be included together in the RRC Setup message.
   masterCellGroup and radioBearerConfig
RRC setup complete message; This message is sent from the UE 3 to the (R)AN node 5. In addition to the parameters that are disclosed by Aspects in this disclosure, following parameters may be included together in the RRC setup complete message.
   guami-Type, iab-NodeIndication, idleMeas Available, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message; This message is sent from the UE 3 to the AMF 70. In addition to the parameters that are disclosed by Aspects in this disclosure, following parameters may be included together in the registration request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, NGC indication and Requested NB-N1 mode DRX parameters.
registration accept message; This message is sent from the AMF 70 to the UE 3. In addition to the parameters that are disclosed by Aspects in this disclosure, following parameters may be included together in the registration accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message; This message is sent from the UE 3 to the AMF 70. In addition to the parameters that are disclosed by Aspects in this disclosure, following parameters may be included together in the Registration Complete message.
   SOR transparent container.
Authentication Request message; This message is sent from the AMF 70 to the UE 3. In addition to the parameters that are disclosed by Aspects in this disclosure, following parameters may be included together in the Authentication Request message.
   ngKSI, ABBA, Authentication parameter RAND (5G authentication challenge), Authentication parameter AUTN (5G authentication challenge) and EAP message.
Authentication Response message; This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message; This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message; This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message; This message is sent from the AMF 70 to the UE 3. In addition to the parameters that are disclosed by Aspects in this disclosure, following parameters may be populated together in the Authentication Reject message.
   EAP message.
Service Request message; This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message; This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message; This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message; This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message; This message is sent from the UE 3 to the AMF 70. In addition to the parameters that are disclosed by Aspects in this disclosure, following parameters may be populated together in the Configuration Update Complete message.
   Configuration update complete message identity.

### <User Equipment (UE)>

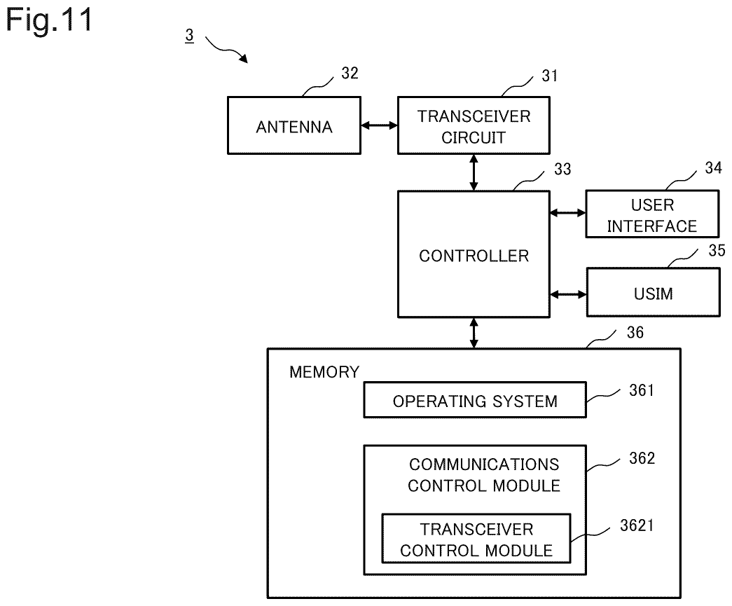

FIG. 11 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as; boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as; rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as; electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as; audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as; an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as; a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

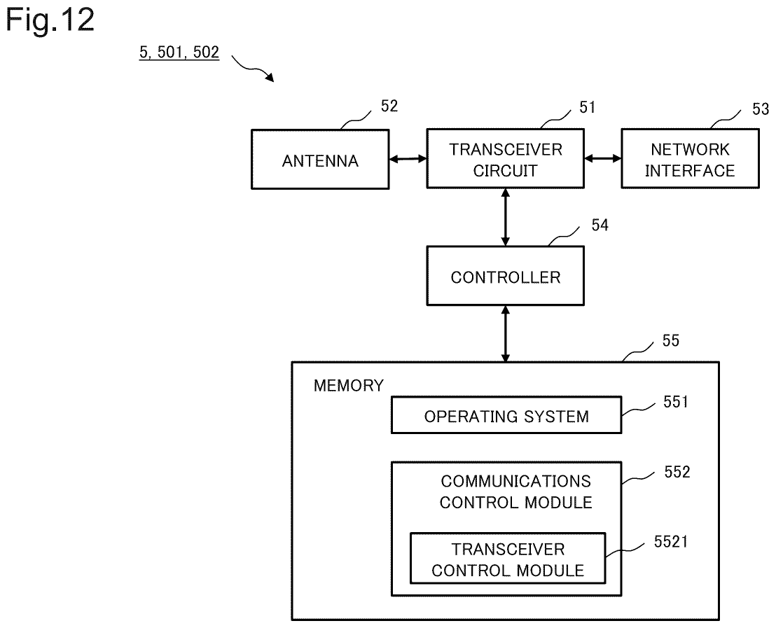

FIG. 12 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN). A Master Node (MN) 501 and a Secondary Node (SN) 502 may have same components to the (R)AN node 5.

### <System Overview of (R)AN Node 5 Based on O-RAN Architecture>

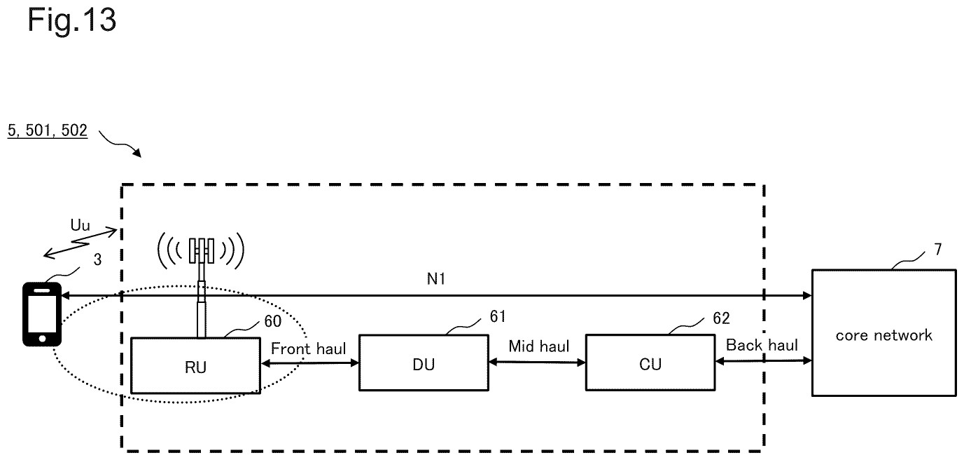

FIG. 13 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

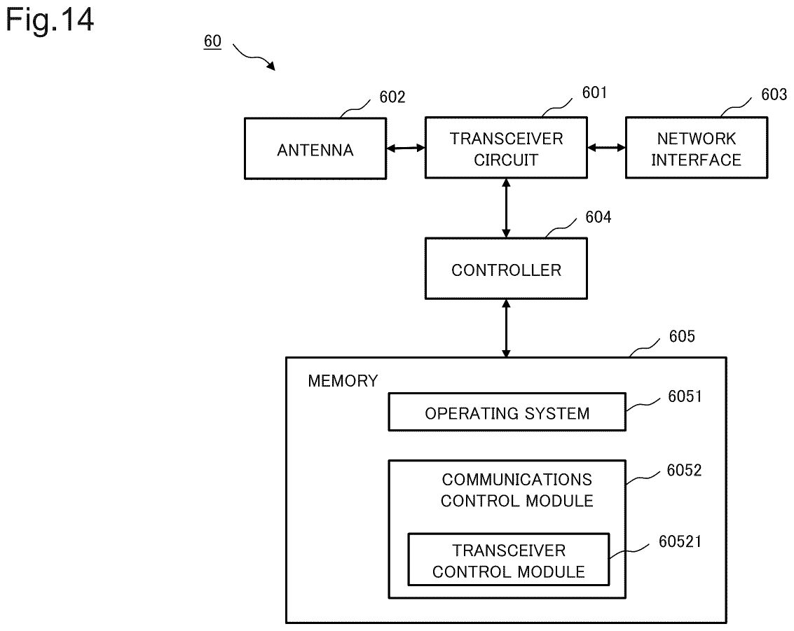

FIG. 14 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

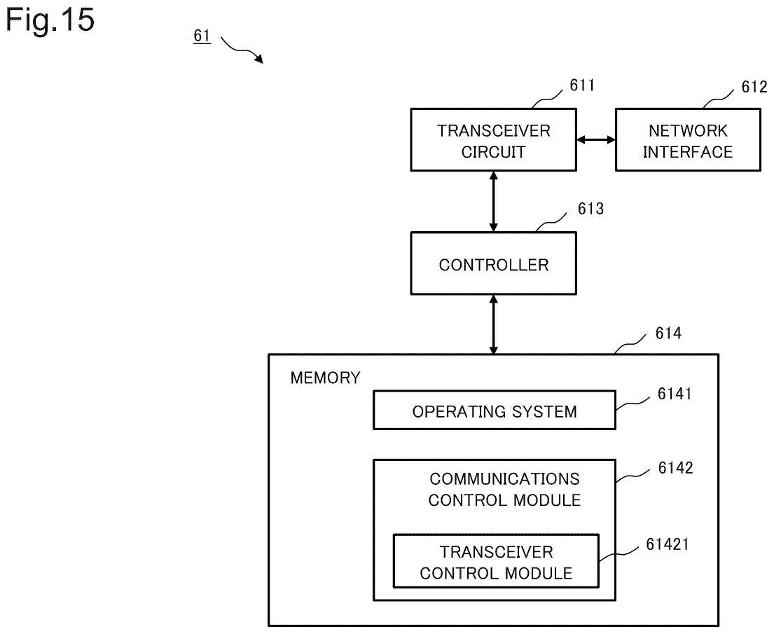

FIG. 15 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

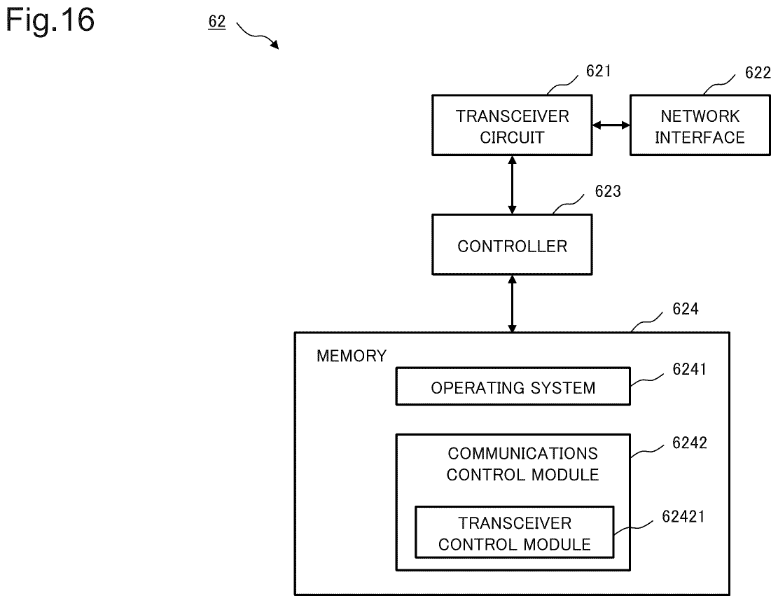

FIG. 16 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

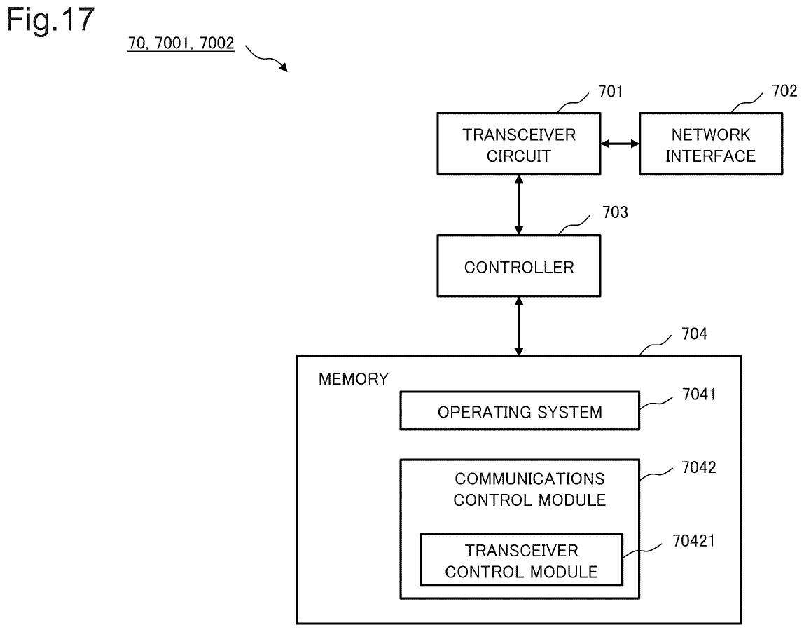

FIG. 17 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN). An AMF 7001 and an AMF 7002 may have same components to the AMF 70.

### <PCF>

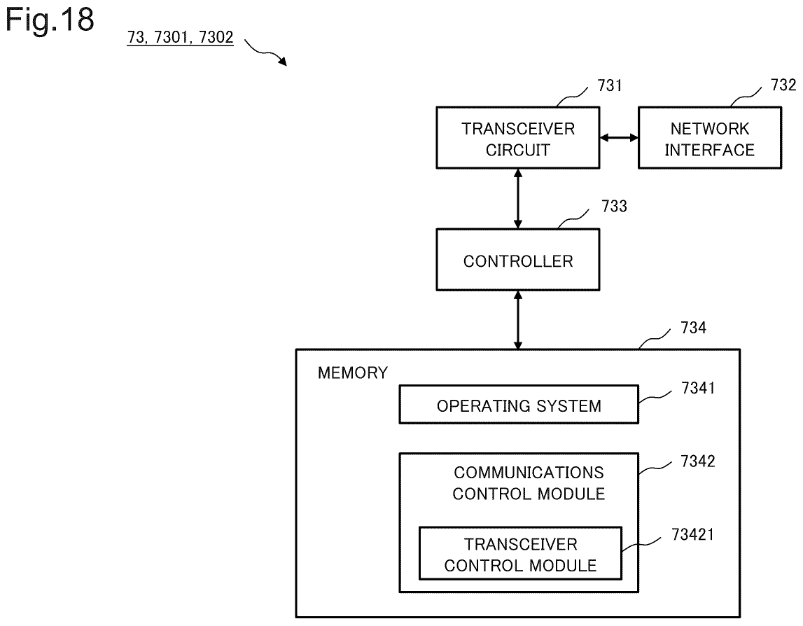

FIG. 18 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). A PCF 7301 and a PCF 7302 may have same components to the PCF 73.

### <AUSF>

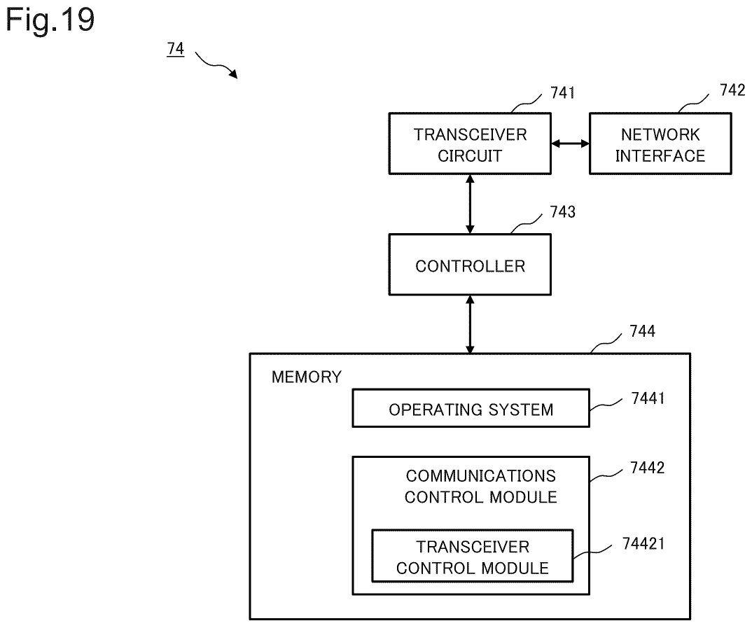

FIG. 19 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### <UDM>

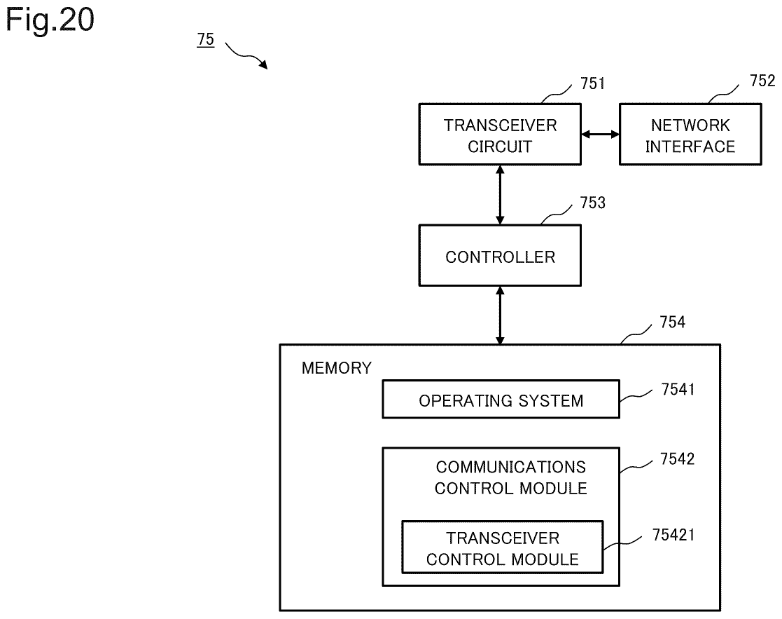

FIG. 20 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example; one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### <Supplementary Notes>

The whole or part of the example Aspects disclosed above can be described as, but not limited to, the following supplementary notes.

supplementary note 1. A method of a User Equipment (UE), the method comprising:
sending first information indicating a first network slice which is available in a first network where the UE is located and second information indicating a second network slice which is required by a service or an application activated in the UE and is not available on the first network; and
receiving third information indicating a second network where the second network slice is available.

supplementary note 2. The method according to supplementary note 1, further comprising:
performing a registration procedure to the second network.

supplementary note 3. The method according to supplementary note 1 or 2,
wherein the first information is included in a registration request message, and
wherein the second information is included in a registration accept message.

supplementary note 4. The method according to any one of supplementary notes 1 to 3,
wherein the first information and the second information are ciphered.

supplementary note 5. A method of a communication apparatus, the method comprising:
receiving first information indicating a first network slice which is available in a first network where a User equipment (UE) is located and second information indicating a second network slice which is required by a service or an application activated in the UE and is not available on the first network; and
sending third information indicating a second network where the second network slice is available.

supplementary note 6. The method according to supplementary note 5, further comprising:
storing the first information and the second information.

supplementary note 7. The method according to supplementary note 5 or 6,
wherein the communication apparatus is Unified Data Management (UDM).

supplementary note 8. A method of a User Equipment (UE), the method comprising:
receiving first information indicating a first network where a first network slice is available; and
sending second information indicating a second network slice which is available in a second network where the UE is located and third information indicating the first network slice which is required by a service or an application activated in the UE and is not available on the second network after receiving the first information.

supplementary note 9. A method of a communication apparatus, the method comprising:
sending first information indicating a first network where a first network slice is available; and
receiving second information indicating a second network slice which is available in a second network where a User Equipment (UE) is located and third information indicating the first network slice which is required by a service or an application activated in the UE and is not available on the second network after sending the first information.

supplementary note 10. The method according to supplementary note 9,
wherein the communication apparatus is Unified Data Management (UDM).

supplementary note 11. A method of a User Equipment (UE), the method comprising:
receiving a request to send first information indicating a first network slice which is available in a first network where the UE is located and second information indicating a second network slice which is required by a service or an application activated in the UE and is not available on the first network; and
sending the first information and the second information after receiving the request.

supplementary note 12. A method of a communication apparatus, the method comprising:
sending a request to send first information indicating a first network slice which is available in a first network where a User Equipment (UE) is located and second information indicating a second network slice which is required by a service or an application activated in the UE and is not available on the first network; and
receiving the first information and the second information after sending the request.

supplementary note 13. The method according to supplementary note 12,
wherein the communication apparatus is Unified Data Management (UDM).

supplementary note 14. A method of a User Equipment (UE), the method comprising:
sending first information indicating a first network slice to which the UE requests to register in a first network; and
receiving second information indicating a second network slice,
wherein the second network slice is a network slice to which the UE is subscribed and which is different from the first network slice and which is available in a second network.

supplementary note 15. The method according to supplementary note 14, further comprising:
performing a registration to the second network slice in the second network.

supplementary note 16. The method according to supplementary note 14 or 15,
wherein the second information is included in information indicating UE Route Selection Policy.

supplementary note 17. A method of a communication apparatus, the method comprising:
receiving first information indicating a first network slice to which a User Equipment (UE) requests to register in a first network; and
sending second information indicating a second network slice, wherein the second network slice is a network slice to which the UE is subscribed and which is different from the first network slice and which is available in a second network.

supplementary note 18. The method according to supplementary note 17,
wherein the second information is included in information indicating UE Route Selection Policy.

supplementary note 19. The method according to supplementary note 17 or 18,
wherein the communication apparatus is Unified Data Management (UDM).

supplementary note 20. A User Equipment (UE) comprising:
means for sending first information indicating a first network slice which is available in a first network where the UE is located and second information indicating a second network slice which is required by a service or an application activated in the UE and is not available on the first network; and
means for receiving third information indicating a second network where the second network slice is available.

supplementary note 21. The UE according to supplementary note 20, further comprising:
means for performing a registration procedure to the second network.

supplementary note 22. The UE according to supplementary note 20 or 21,
wherein the first information is included in a registration request message, and
wherein the second information is included in a registration accept message.

supplementary note 23. The UE according to any one of supplementary notes 20 to 22,
wherein the first information and the second information are ciphered.

supplementary note 24. A communication apparatus comprising:
means for receiving first information indicating a first network slice which is available in a first network where a User equipment (UE) is located and second information indicating a second network slice which is required by a service or an application activated in the UE and is not available on the first network; and
means for sending third information indicating a second network where the second network slice is available.

supplementary note 25. The communication apparatus according to supplementary note 24, further comprising:
means for storing the first information and the second information.

supplementary note 26. The communication apparatus according to supplementary note 24 or 25,
wherein the communication apparatus is Unified Data Management (UDM).

supplementary note 27. A User Equipment (UE) comprising: means for receiving first information indicating a first
network where a first network slice is available; and means for sending second information indicating a second network slice which is available in a second network where the UE is located and third information indicating the first network slice which is required by a service or an application activated in the UE and is not available on the second network after receiving the first information.

supplementary note 28. A communication apparatus comprising:
sending first information indicating a first network where a first network slice is available; and
receiving second information indicating a second network slice which is available in a second network where a User Equipment (UE) is located and third information indicating the first network slice which is required by a service or an application activated in the UE and is not available on the second network after sending the first information.

supplementary note 29. The communication apparatus according to supplementary note 28,
wherein the communication apparatus is Unified Data Management (UDM).

supplementary note 30. A User Equipment (UE) comprising:
means for receiving a request to send first information indicating a first network slice which is available in a first network where the UE is located and second information indicating a second network slice which is required by a service or an application activated in the UE and is not available on the first network; and
means for sending the first information and the second information after receiving the request.

supplementary note 31. A communication apparatus comprising:
means for sending a request to send first information indicating a first network slice which is available in a first network where a User Equipment (UE) is located and second information indicating a second network slice which is required by a service or an application activated in the UE and is not available on the first network; and
means for receiving the first information and the second information after sending the request.

supplementary note 32. The communication apparatus according to supplementary note 31,
wherein the communication apparatus is Unified Data Management (UDM).

supplementary note 33. A User Equipment (UE) comprising:
means for sending first information indicating a first network slice to which the UE requests to register in a first network; and means for receiving second information indicating a second network slice,
wherein the second network slice is a network slice to which the UE is subscribed and which is different from the first network slice and which is available in a second network.

supplementary note 34. The UE according to supplementary note 33, further comprising:
means for performing a registration to the second network slice in the second network.

supplementary note 35. The UE according to supplementary note 33 or 34,
wherein the second information is included in information indicating UE Route Selection Policy.

supplementary note 36. A communication apparatus comprising:
means for receiving first information indicating a first network slice to which a User Equipment (UE) requests to register in a first network; and
means for sending second information indicating a second network slice,
wherein the second network slice is a network slice to which the UE is subscribed and which is different from the first network slice and which is available in a second network.

supplementary note 37. The communication apparatus according to supplementary note 36,
wherein the second information is included in information indicating UE Route Selection Policy.

supplementary note 38. The communication apparatus according to supplementary note 36 or 37,
wherein the communication apparatus is Unified Data Management (UDM).

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111057371, filed on Dec. 9, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 AUSF
75 UDM
76 NWDAF
361 operating system
362 communications control module
501 Cell
502 Cell
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
731 transceiver circuit
732 network interface
733 controller
734 memory
741 transceiver circuit
742 network interface
743 controller
744 memory
751 transceiver circuit
752 network interface
753 controller
754 memory
3621 transceiver control module
5521 transceiver control module
6051 operating system
6052 communications control module
6141 operating system
6142 communications control module
6241 operating system
6242 communications control module
7001 AMF
7002 AMF
7041 operating system
7042 communications control module
7341 operating system
7342 communications control module
7441 operating system
7442 communications control module
7301 PCF
7302 PCF
7541 operating system
7542 communications control module
60521 transceiver control module
61421 transceiver control module
62421 transceiver control module
70421 transceiver control module
73421 transceiver control module
74421 transceiver control module
75421 transceiver control module

What is claimed is:

1. A method of a User Equipment (UE), the method comprising:
sending first information indicating a first network slice which is available in a first network where the UE is located and second information indicating a second network slice which is required by a service or an application activated in the UE and is not available on the first network; and
receiving third information indicating a second network where the second network slice is available.

2. The method according to claim 1, further comprising:
performing a registration procedure to the second network.

3. The method according to claim 1,
wherein the first information is included in a registration request message, and
wherein the second information is included in a registration accept message.

4. The method according to claim 1,
wherein the first information and the second information are ciphered.

5. A method of a communication apparatus, the method comprising:
receiving first information indicating a first network slice which is available in a first network where a User equipment (UE) is located and second information indicating a second network slice which is required by a service or an application activated in the UE and is not available on the first network; and
sending third information indicating a second network where the second network slice is available.

6. The method according to claim 5, further comprising:
storing the first information and the second information.

7. The method according to claim 5,
wherein the communication apparatus is Unified Data Management (UDM).

8.-19. (canceled)

20. A User Equipment (UE) comprising one or more memories storing instructions and one or more processors configured to execute the instructions to;
send first information indicating a first network slice which is available in a first network where the UE is located and second information indicating a second network slice which is required by a service or an application activated in the UE and is not available on the first network; and
receive third information indicating a second network where the second network slice is available.

21.-38. (canceled)
